(19) United States
(12) Patent Application Publication
(10) Pub. No.: US 2024/0222647 A1
(43) Pub. Date: Jul. 4, 2024

(54) BATTERY AND METHOD FOR MANUFACTURING BATTERY

(71) Applicant: Panasonic Intellectual Property Management Co., Ltd., Osaka (JP)

(72) Inventors: KAZUYOSHI HONDA, Osaka (JP); KOICHI HIRANO, Osaka (JP); EIICHI KOGA, Hokkaido (JP); KAZUHIRO MORIOKA, Osaka (JP); AKIRA KAWASE, Osaka (JP)

(21) Appl. No.: 18/605,804

(22) Filed: Mar. 14, 2024

Related U.S. Application Data
(63) Continuation of application No. PCT/JP2022/027919, filed on Jul. 15, 2022.

(30) Foreign Application Priority Data
Oct. 6, 2021 (JP) 2021-164939

(51) Int. Cl. H01M 4/70; H01M 4/66; H01M 4/82; H01M 10/052; H01M 10/0562

(52) U.S. Cl. CPC H01M 4/70; H01M 4/82; H01M 10/052; H01M 10/0562; H01M 4/661

(57) ABSTRACT

Each of the plurality of power-generating layers includes an electrode layer, a counter electrode layer, and a solid electrolyte layer located between the electrode layer and the counter electrode layer, a plurality of current collectors each include a counter electrode current collector that is electrically connected to the counter electrode layer, and an electrode current collector that is electrically connected to the electrode layer, the plurality of power-generating layers are laminated so as to be electrically connected in parallel, the power-generating layers being adjacent to each other are laminated while interposing at least one current collector out of the plurality of current collectors, each of the power-generating layers of a power-generating element is sandwiched between two adjacent current collectors out of the plurality of current collectors, a side surface of the power-generating element includes a first region and a second region.

### BACKGROUND

### 1. Technical Field

The present disclosure relates to a battery and a method for manufacturing a battery.

### 2. Description of the Related Art

There has heretofore been known a laminated battery such as an all-solid-state battery formed by laminating electrodes and solid electrolyte layers.

Japanese Unexamined Patent Application Publication No. 2013-120717 discloses a concept of electrically connecting unit cells in parallel by using end surfaces thereof, in which the unit cells are laminated so as to be electrically connected in series.

Japanese Unexamined Patent Application Publication No. 2008-198492 discloses a concept of causing current collectors to project in order to electrically connect unit cells in parallel by using end surfaces thereof, in which the unit cells are laminated so as to be electrically connected in series.

### SUMMARY

Regarding the related art, there is a demand for further enhancement in an energy density, large-current characteristics, and reliability of a battery.

In a case of battery formed by laminating unit cells, it is important to establish convenient and reliable connection among the laminated unit cells while realizing a high energy density.

On the other hand, each unit cell is small in thickness and therefore has a difficulty in securing a connection region on each end surface of the unit cell.

One non-limiting and exemplary embodiment provides a battery and a method for manufacturing a battery, which enhance an energy density, large-current characteristics, and reliability thereof.

In one general aspect, the techniques disclosed here feature a battery including: a power-generating element having a structure in which a plurality of power-generating layers and a plurality of current collectors are laminated, in which each of the plurality of power-generating layers includes an electrode layer, a counter electrode layer, and a solid electrolyte layer located between the electrode layer and the counter electrode layer, the plurality of current collectors each include a counter electrode current collector that is electrically connected to the counter electrode layer, and an electrode current collector that is electrically connected to the electrode layer, the plurality of power-generating layers are laminated so as to be electrically connected in parallel, the power-generating layers being adjacent to each other are laminated while interposing at least one current collector out of the plurality of current collectors, each of the power-generating layers of the power-generating element is sandwiched between two adjacent current collectors out of the plurality of current collectors, a side surface of the power-generating element includes a first region where each of the power-generating layers does not recede from the current collector out of the plurality of current collectors which is adjacent to each of the power-generating layers, and a second region where each of the power-generating layers recedes from the current collector out of the plurality of current collectors which is adjacent to each of the power-generating layers so as to form a recess, and the battery includes an insulating member that covers the electrode layer and the electrode current collector in the second region, and a conductive member that covers the second region and the insulating member, and is electrically connected to at least one of principal surfaces of the counter electrode current collector.

According to the present disclosure, it is possible to enhance an energy density, large-current characteristics, and reliability of a battery.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a side view of a battery according to Embodiment 1;

FIG. 2A is a sectional view of the battery according to the Embodiment 1;

FIG. 2B is another sectional view of the battery according to the Embodiment 1;

FIG. 3 is a top plan view of the battery according to the Embodiment 1;

FIG. 4 is a side view of a battery according to Modified Example 1 of the Embodiment 1;

FIG. 5A is a sectional view of the battery according to the Modified Example 1 of the Embodiment 1;

FIG. 5B is another sectional view of the battery according to the Modified Example 1 of the Embodiment 1;

FIG. 6A is a sectional view of a battery according to Modified Example 2 of the Embodiment 1;

FIG. 6B is another sectional view of the battery according to the Modified Example 2 of the Embodiment 1;

FIG. 7A is a sectional view of a battery according to Modified Example 3 of the Embodiment 1;

FIG. 7B is another sectional view of the battery according to the Modified Example 3 of the Embodiment 1;

FIG. 8A is a sectional view of a battery according to Modified Example 4 of the Embodiment 1;

FIG. 8B is another sectional view of the battery according to the Modified Example 4 of the Embodiment 1;

FIG. 9A is a sectional view of a battery according to Modified Example 5 of the Embodiment 1;

FIG. 9B is another sectional view of the battery according to the Modified Example 5 of the Embodiment 1;

FIG. 10 is a side view of a battery according to Modified Example 6 of the Embodiment 1;

FIG. 11 is a side view of a battery according to Modified Example 7 of the Embodiment 1;

FIG. 12 is a side view of a battery according to Modified Example 8 of the Embodiment 1;

FIG. 13 is a side view of a battery according to Modified Example 9 of the Embodiment 1;

FIG. 14A is a sectional view of a battery according to Modified Example 10 of the Embodiment 1;

FIG. 14B is another sectional view of the battery according to the Modified Example 10 of the Embodiment 1;

FIG. 15 is a side view of a battery according to Modified Example 11 of the Embodiment 1;

FIG. 16A is a sectional view of a battery according to Modified Example 12 of the Embodiment 1;

FIG. 16B is another sectional view of the battery according to the Modified Example 12 of the Embodiment 1;

FIG. 17A is a sectional view of a battery according to Modified Example 13 of the Embodiment 1;

FIG. 17B is another sectional view of the battery according to the Modified Example 13 of the Embodiment 1;

FIG. 18A is a sectional view of a battery according to Modified Example 14 of the Embodiment 1;

FIG. 18B is another sectional view of the battery according to the Modified Example 14 of the Embodiment 1;

FIG. 19A is a sectional view of a battery according to Embodiment 2;

FIG. 19B is another sectional view of the battery according to the Embodiment 2;

FIG. 20A is a sectional view of a battery according to Modified Example 1 of the Embodiment 2;

FIG. 20B is another sectional view of the battery according to the Modified Example 1 of the Embodiment 2;

FIG. 21 is a side view of a battery according to Modified Example 2 of the Embodiment 2;

FIG. 22A is a sectional view of the battery according to the Modified Example 2 of the Embodiment 2;

FIG. 22B is another sectional view of the battery according to the Modified Example 2 of the Embodiment 2;

FIG. 23 is a side view of a battery according to Modified Example 3 of the Embodiment 2;

FIG. 24A is a sectional view of a battery according to Modified Example 4 of the Embodiment 2;

FIG. 24B is another sectional view of the battery according to the Modified Example 4 of the Embodiment 2;

FIG. 25 is a flowchart illustrating an example of a method for manufacturing a battery according to an embodiment or a modified example thereof;

FIG. 26A is a sectional view of an example of a unit cell according to the embodiment or the modified example thereof;

FIG. 26B is a sectional view of another example of the unit cell according to the embodiment or the modified example thereof; and

FIG. 26C is a sectional view of still another example of the unit cell according to the embodiment or the modified example thereof.

### DETAILED DESCRIPTIONS

### Summary of Present Disclosure

A battery according to an aspect of the present disclosure includes: a power-generating element having a structure in which a plurality of power-generating layers and a plurality of current collectors are laminated, in which each of the plurality of power-generating layers includes an electrode layer, a counter electrode layer, and a solid electrolyte layer located between the electrode layer and the counter electrode layer, the plurality of current collectors each include a counter electrode current collector that is electrically connected to the counter electrode layer, and an electrode current collector that is electrically connected to the electrode layer, the plurality of power-generating layers are laminated so as to be electrically connected in parallel, the power-generating layers being adjacent to each other are laminated while interposing at least one current collector out of the plurality of current collectors, each of the power-generating layers of the power-generating element is sandwiched between two adjacent current collectors out of the plurality of current collectors, a side surface of the power-generating element includes a first region where each of the power-generating layers does not recede from the current collector out of the plurality of current collectors which is adjacent to each of the power-generating layers, and a second region where each of the power-generating layers recedes from the current collector out of the plurality of current collectors which is adjacent to each of the power-generating layers so as to form a recess, and the battery includes an insulating member that covers the electrode layer and the electrode current collector in the second region, and a conductive member that covers the second region and the insulating member, and is electrically connected to at least one of principal surfaces of the counter electrode current collector.

As such, in the second region, the conductive member such as a terminal for extracting an electric current can be connected to the principal surface on the recess side of the current collector inside the recess. Thus, a connection area between the terminal and the current collector can be increased and resistance at a connecting portion can be reduced as compared to a case of connecting the terminal to a side surface of the current collector. Accordingly, it is possible to enhance large-current characteristics of the battery. Meanwhile, the increase in connection area between the terminal and the current collector enhances a mechanical connection strength between the terminal the current collector, so that reliability of the battery can be improved.

Meanwhile, in the second region, the current collector projects from a side surface of the power-generating layer. On the other hand, the power-generating layer does not recede in the first region. Accordingly, the current collector and the power-generating layer are laminated and disposed at a position of a tip end of the current collector projecting in the second region. Usually, when the current collector projects, a projecting portion of the current collector is prone to deformation while moving in the direction of lamination. However, the current collector projecting in the second region is supported by the power-generating layer in the adjacent first region and is less likely to move. Thus, an interval of the current collectors tends to be kept constant. Accordingly, the current collectors are kept from coming into contact with each other to cause a short circuit or from coming close to each other to cause a short circuit discharge in the process of manufacturing the battery and when the battery is in use. Thus, reliability of the battery can be improved.

In the meantime, on the side surface of the power-generating element, the power-generating layers recede only in the second region out of the first region and the second region. Thus, it is possible to reduce the regions where the power-generating layers recede, so that an energy density of the battery can be enhanced.

Meanwhile, the insulating member covers the electrode layer in the second region according to this configuration, so that the occurrence of a short circuit between the counter electrode layer and the electrode layer through the conductive member can be suppressed.

In the meantime, the battery with a large capacity can be realized by laminating the power-generating layers so as to be electrically connected in parallel. In this case, the electrodes of the same polarity on the respective layers are electrically connected to one another through terminals connected to the current collectors, for example.

For example, the first regions may be located on the side surface so as to sandwich the second region from both sides in a direction perpendicular to a direction of lamination of the power-generating element.

As such, the current collector projecting in the second region is supported by the power-generating layers in the first regions on both sides. As a consequence, each current collector is apt to be strained and the interval of the current collectors in the second region is maintained more appropriately.

For example, the recesses formed by recession of the respective power-generating layers may be arranged in the second region in a direction of lamination of the power-generating element.

As such, the recesses in the second region can be formed by processing the recesses in a lump, so that the second region can be formed easily.

For example, a maximum depth of the recess may be larger than a width of the recess in a direction of lamination of the power-generating element.

As such, it is possible to increase a connection area between the terminal and the current collector in a case where the terminal is connected to the current collector in the recess, so that the large-current characteristics of the battery can be enhanced.

For example, the second regions may be separated by the first region.

As such, the widths of the individual separated second regions are reduced. Accordingly, the current collector projecting in each second region is less likely to move so that the interval between the current collectors is maintained more constantly.

For example, a length of the second region in a direction perpendicular to a direction of lamination of the power-generating element may be larger than a length of the first region in the direction perpendicular to the direction of lamination of the power-generating element on the side surface.

As such, it is possible to increase the connection area between the terminal and the current collector in the case where the terminal is connected to the current collector in the recess in the second region, so that the large-current characteristics of the battery can be enhanced.

For example, the conductive member may cover principal surfaces on both sides of the current collector that is adjacent to the recess.

As such, it is possible to increase a connection area between the conductive member and the current collector, so that the large-current characteristics of the battery can be enhanced and reliability of the battery can be improved by enhancing a mechanical connection strength between the terminal and the current collector.

For example, the battery further may include: an insulating member that covers each of the power-generating layers in the second region.

As such, the side surface of the power-generating layer in the second region is covered with the insulating member. Thus, it is possible to suppress collapse of materials on side surfaces of the respective layers constituting the power-generating layer as well as the occurrence of a short circuit.

For example, the counter electrode layer may recede from the electrode layer in the second region.

As such, the recess can be formed by causing the counter electrode layer to recede in a state of protecting the electrode layer with the insulating member, for example. Thus, it is possible to simplify the manufacturing process.

For example, the insulating member further may cover at least part of the solid electrolyte layer in the second region.

As such, by forming the insulating member so as to further cover part of the solid electrolyte layer, it is possible to suppress exposure of the electrode layer without being covered with the insulating member even if there is a variation in size of the insulating member. Meanwhile, very fine asperities are present on a side surface of the solid electrolyte layer which is made of a powder material in general. For this reason, an adhesion strength of the insulating member is enhanced and insulation reliability is improved.

For example, the insulating member further may cover the first region.

As such, the first region is also covered with the insulating member. Accordingly, it is possible to suppress the collapse of the materials on side surfaces of the respective layers constituting the power-generating layer as well as the occurrence of a short circuit in the first region as well.

A method for manufacturing according to an aspect of the present disclosure is a method for manufacturing a battery including: a first step of preparing a plurality of unit cells each having a structure in which a power-generating layer and a current collector are laminated, the power-generating layer including an electrode layer, a counter electrode layer, and a solid electrolyte layer located between the electrode layer and the counter electrode layer; and a second step of forming a power-generating element by laminating the plurality of unit cells, in which the second step is a step of connecting the plurality of unit cells in parallel and includes providing a side surface of the power-generating element with a first region where each of power-generating layers of the plurality of unit cells does not recede from the current collector located adjacent to each of the power-generating layers among the current collectors of the plurality of unit cells, and with a second region where a recess is formed by causing each of the power-generating layers to recede from the current collector located adjacent to each of the power-generating layers among the current collectors of the plurality of unit cells, and an insulating member that covers the electrode layer and an electrode current collector being electrically connected to the electrode layer in the second region, and a conductive member that covers the second region and the insulating member and is electrically connected to at least one of principal surfaces of a counter electrode current collector being electrically connected to the counter electrode layer are provided.

As such, in the formed second region, the conductive member such as a terminal for extracting an electric current can be connected to the principal surface on the recess side of the current collector inside the recess. Thus, a connection area between the terminal and the current collector can be increased and resistance at a connecting portion can be reduced as compared to the case of connecting the terminal to a side surface of the current collector. Accordingly, it is possible to enhance large-current characteristics of the manufactured battery. Meanwhile, the increase in connection area between the terminal and the current collector enhances a mechanical connection strength between the terminal the current collector, so that reliability of the manufactured battery can be improved.

Meanwhile, in the formed second region, the current collector projects from a side surface of the power-generating layer. On the other hand, the power-generating layer does not recede in the formed first region. Accordingly, the current collector and the power-generating layer are laminated and disposed at a position of a tip end of the current collector projecting in the second region. Usually, when the current collector projects, a projecting portion of the current collector is prone to deformation while moving in the direction of lamination. However, the current collector projecting in the second region is supported by the power-generating layer in the adjacent first region and is less likely to move. Thus, an interval of the current collectors tends to be kept constant. Accordingly, the current collectors are kept from coming into contact with each other to cause a short circuit or from coming close to each other to cause a short circuit discharge in the process of manufacturing the battery and when the manufactured battery is in use. Thus, reliability of the manufactured battery can be improved.

In the meantime, on the side surface of the power-generating element, the power-generating layers recede only in the second region out of the first region and the second region. Thus, it is possible to reduce the regions where the power-generating layers recede, so that an energy density of the manufactured battery can be enhanced.

Meanwhile, the insulating member covers the electrode layer in the second region according to this configuration, so that the occurrence of a short circuit between the counter electrode layer and the electrode layer through the conductive member can be suppressed.

In the meantime, the battery with a large capacity can be realized by laminating the power-generating layers so as to be electrically connected in parallel. In this case, the electrodes of the same polarity on the respective layers are electrically connected to one another through terminals connected to the current collectors, for example.

For example, the recess may be formed in the second step such that the first regions sandwich the second region from both sides in a direction perpendicular to a direction of lamination of the power-generating element.

As such, the current collector projecting in the formed second region is supported by the power-generating layers in the first regions on both sides. As a consequence, each current collector is apt to be strained and the interval of the current collectors in the second region is maintained more appropriately.

For example, the recess may be formed in the second step by subjecting each of the power-generating layers to any of partial cutting, polishing, sandblasting, brushing, etching, laser irradiation, and plasma irradiation.

In this way, the recess can be formed easily.

A battery according to another aspect of the present disclosure includes: a power-generating element having a structure in which a plurality of power-generating layers and a plurality of current collectors are laminated, in which each of the plurality of power-generating layers includes an electrode layer, a counter electrode layer, and a solid electrolyte layer located between the electrode layer and the counter electrode layer, the plurality of power-generating layers are laminated so as to be electrically connected in parallel, the power-generating layers being adjacent to each other are laminated while interposing at least one current collector out of the plurality of current collectors, each of the power-generating layers of the power-generating element is sandwiched between adjacent current collectors out of the plurality of current collectors, a side surface of the power-generating element includes a first region where each of the power-generating layers does not recede from the current collector out of the plurality of current collectors which is adjacent to each of the power-generating layers, and a second region where each of the power-generating layers recedes from the current collector out of the plurality of current collectors which is adjacent to each of the power-generating layers so as to form a recess.

As such, in the second region, the conductive member such as a terminal for extracting an electric current can be connected to the principal surface on the recess side of the current collector inside the recess. Thus, a connection area between the terminal and the current collector can be increased and resistance at a connecting portion can be reduced as compared to a case of connecting the terminal to a side surface of the current collector. Accordingly, it is possible to enhance large-current characteristics of the battery. Meanwhile, the increase in connection area between the terminal and the current collector enhances a mechanical connection strength between the terminal the current collector, so that reliability of the battery can be improved.

Meanwhile, in the second region, the current collector projects from a side surface of the power-generating layer. On the other hand, the power-generating layer does not recede in the first region. Accordingly, the current collector and the power-generating layer are laminated and disposed at a position of a tip end of the current collector projecting in the second region. Usually, when the current collector projects, a projecting portion of the current collector is prone to deformation while moving in the direction of lamination. However, the current collector projecting in the second region is supported by the power-generating layer in the adjacent first region and is less likely to move. Thus, an interval of the current collectors tends to be kept constant. Accordingly, the current collectors are kept from coming into contact with each other to cause a short circuit or from coming close to each other to cause a short circuit discharge in the process of manufacturing the battery and when the battery is in use. Thus, reliability of the battery can be improved.

In the meantime, on the side surface of the power-generating element, the power-generating layers recede only in the second region out of the first region and the second region. Thus, it is possible to reduce the regions where the power-generating layers recede, so that an energy density of the battery can be enhanced.

For example, the first regions may be located on the side surface so as to sandwich the second region from both sides in a direction perpendicular to a direction of lamination of the power-generating element.

As such, the current collector projecting in the second region is supported by the power-generating layers in the first regions on both sides. As a consequence, each current collector is apt to be strained and the interval of the current collectors in the second region is maintained more appropriately.

For example, the recesses formed by recession of the respective power-generating layers may be arranged in the second region in a direction of lamination of the power-generating element.

As such, the recesses in the second region can be formed by processing the recesses in a lump, so that the second region can be formed easily.

For example, a maximum depth of the recess may be larger than a width of the recess in a direction of lamination of the power-generating element.

As such, it is possible to increase a connection area between the terminal and the current collector in the case where the terminal is connected to the current collector in the recess, so that the large-current characteristics of the battery can be enhanced.

For example, the second regions may be separated by the first region.

As such, the widths of the individual separated second regions are reduced. Accordingly, the current collector projecting in each second region is less likely to move so that the interval between the current collectors is maintained more constantly.

For example, a length of the second region in a direction perpendicular to a direction of lamination of the power-generating element may be larger than a length of the first region in the direction perpendicular to the direction of lamination of the power-generating element on the side surface.

As such, it is possible to increase the connection area between the terminal and the current collector in the case where the terminal is connected to the current collector in the recess in the second region, so that the large-current characteristics of the battery can be enhanced.

Meanwhile, the power-generating layers may be laminated so as to be electrically connected in parallel.

Thus, the battery with a large capacity can be realized. In this case, the electrodes of the same polarity on the respective layers are electrically connected to one another through terminals connected to the current collectors, for example.

Meanwhile, the power-generating layers may be laminated so as to be electrically connected in series.

Thus, the battery with a high voltage can be realized. In this case, voltages on the respective power-generating layers can be monitored one by one through terminals connected to the current collectors, for example.

Meanwhile, the battery may further include a conductive member which is electrically connected to at least one of principal surfaces of the current collector adjacent to the recess among the multiple current collectors in the second region.

As such, the conductive member with the increased connection area to the current collector as a consequence of being electrically connected to the principal surface of the current collector can be used as the terminal and the like.

For example, the conductive member may cover principal surfaces on both sides of the current collector that is adjacent to the recess.

As such, it is possible to increase a connection area between the conductive member and the current collector, so that the large-current characteristics of the battery can be enhanced and reliability of the battery can be improved by enhancing the mechanical connection strength between the terminal and the current collector.

For example, the battery further may include: an insulating member that covers each of the power-generating layers in the second region.

As such, the side surface of the power-generating layer in the second region is covered with the insulating member. Thus, it is possible to suppress collapse of materials on side surfaces of the respective layers constituting the power-generating layer as well as the occurrence of a short circuit.

In the meantime, the multiple current collectors may each include a counter electrode current collector that is electrically connected to the counter electrode layer, and an electrode current collector that is electrically connected to the electrode layer. Meanwhile, the battery may include an insulating member that covers the electrode layer and the electrode current collector in the second region, and a conductive member that covers the second region and the insulating member, and is electrically connected to at least one of principal surfaces of the counter electrode current collector.

As such, the insulating member covers the electrode layer in the second region, so that the occurrence of a short circuit between the counter electrode layer and the electrode layer through the conductive member can be suppressed.

For example, the counter electrode layer may recede from the electrode layer in the second region.

As such, the recess can be formed by causing the counter electrode layer to recede in a state of protecting the electrode layer with the insulating member, for example. Thus, it is possible to simplify the manufacturing process.

For example, the insulating member further may cover at least part of the solid electrolyte layer in the second region.

As such, by forming the insulating member so as to further cover part of the solid electrolyte layer, it is possible to suppress exposure of the electrode layer without being covered with the insulating member even if there is a variation in size of the insulating member. Meanwhile, very fine asperities are present on a side surface of the solid electrolyte layer which is made of a powder material in general. For this reason, an adhesion strength of the insulating member is enhanced and insulation reliability is improved.

In the meantime, the insulating member may cover the electrode layer of each of the power-generating layers and the counter electrode current collector to be electrically connected to the electrode layer of each of the power-generating layers in the second region. Meanwhile, the conductive member may be electrically connected to the counter electrode current collector that is electrically connected to the counter electrode layer of each of the power-generating layers.

As such, the conductive member can be used for parallel connection of the power-generating layers. Since the conductive member can be brought into close contact with the second region and the insulating member, it is possible to reduce a volume of a portion involved in the parallel connection. Accordingly, an energy density of the battery can be enhanced.

For example, the insulating member further may cover the first region.

In this way, the first region is also covered with the insulating member. Accordingly, it is possible to suppress the collapse of the materials on side surfaces of the respective layers constituting the power-generating layer as well as the occurrence of a short circuit in the first region as well.

A method for manufacturing according to another aspect of the present disclosure includes: a first step of preparing a plurality of unit cells each having a structure in which a power-generating layer and a current collector are laminated, the power-generating layer including an electrode layer, a counter electrode layer, and a solid electrolyte layer located between the electrode layer and the counter electrode layer; and a second step of forming a power-generating element by laminating the plurality of unit cells, in which the second step includes providing a side surface of the power-generating element with a first region where each of power-generating layers of the plurality of unit cells does not recede from the current collector located adjacent to each of the power-generating layers among the current collectors of the plurality of unit cells, and with a second region where a recess is formed by causing each of the power-generating layers to recede from the current collector located adjacent to each of the power-generating layers among the current collectors of the plurality of unit cells.

As such, in the formed second region, the conductive member such as a terminal for extracting an electric current can be connected to the principal surface on the recess side of the current collector inside the recess. Thus, a connection area between the terminal and the current collector can be increased and resistance at a connecting portion can be reduced as compared to a case of connecting the terminal to a side surface of the current collector. Accordingly, it is possible to enhance large-current characteristics of the manufactured battery. Meanwhile, the increase in connection area between the terminal and the current collector enhances a mechanical connection strength between the terminal the current collector, so that reliability of the manufactured battery can be improved.

Meanwhile, in the formed second region, the current collector projects from a side surface of the power-generating layer. On the other hand, the power-generating layer does not recede in the formed first region. Accordingly, the current collector and the power-generating layer are laminated and disposed at a position of a tip end of the current collector projecting in the second region. Usually, when the current collector projects, a projecting portion of the current collector is prone to deformation while moving in the direction of lamination. However, the current collector projecting in the second region is supported by the power-generating layer in the adjacent first region and is less likely to move. Thus, an interval of the current collectors tends to be kept constant. Accordingly, the current collectors are kept from coming into contact with each other to cause a short circuit or from coming close to each other to cause a short circuit discharge in the process of manufacturing the battery and when the manufactured battery is in use. Thus, reliability of the manufactured battery can be improved.

In the meantime, on the side surface of the power-generating element, the power-generating layers recede only in the second region out of the first region and the second region. Thus, it is possible to reduce the regions where the power-generating layers recede, so that an energy density of the manufactured battery can be enhanced.

Meanwhile, the recess may be formed in the second step such the first regions sandwich the second region from both sides in a direction perpendicular to a direction of lamination of the power-generating element, for example.

As such, the current collector projecting in the formed second region is supported by the power-generating layers in the first regions on both sides. As a consequence, each current collector is apt to be strained and the interval of the current collectors in the second region is maintained more appropriately.

Meanwhile, the recess may be formed in the second step by subjecting each of the power-generating layers to any of partial cutting, polishing, sandblasting, brushing, etching, laser irradiation, and plasma irradiation, for example.

In this way, the recess can be formed easily.

Meanwhile, the manufacturing method may further include a third step of forming a conductive member in the second region, the conductive member being electrically connected to at least one of principal surfaces of the current collector adjacent to the recess among the current collectors of the multiple unit cells.

As such, the conductive member that can increase a connection area to the current collector is formed by being electrically connected to the principal surface of the current collector. The conductive member can be used as the terminal and the like.

Embodiments will be specifically described below with reference to the drawings.

Note that each embodiment described below represents a comprehensive or specific example. Numerical values, shapes, materials, constituents, layout positions and modes of connection of the constituents, steps, the order of the steps, and the like depicted in the following embodiment are examples and are not intended to restrict the present disclosure. Meanwhile, of the constituents in the following embodiments, a constituent not defined in an independent claim will be described as an optional constituent.

In the meantime, the respective drawings are schematic diagrams and are not always illustrated precisely. Accordingly, scales and other factors do not always coincide with one another in the respective drawings, for example. Moreover, in the respective drawings, the structures which are substantially the same are denoted by the same reference signs and overlapping explanations thereof may be omitted or simplified.

Meanwhile, in the present specification, terms that represent relations between elements such as parallelism and orthogonality, terms that represent shapes of the elements such as a rectangle and a rectangular parallelepiped, and numerical ranges are not expressions that only represent precise meanings but are rather expressions that encompass substantially equivalent ranges with allowances of several percent, for example.

In the meantime, in the present specification and the drawings, x axis, y axis, and z axis represent three axes of a three-dimensional orthogonal coordinate system. In a case where a shape in plan view of a power-generating element of a battery is a rectangle, the x axis and the y axis coincide with directions parallel to a first side of the rectangle and to a second side being orthogonal to the first side, respectively. The z axis coincides with a direction of lamination of multiple power-generating layers included in the power-generating element.

Meanwhile, in the present specification, a “direction of lamination” of the power-generating element coincides with a direction of a normal line to principal surfaces of current collectors and the power-generating layers. Moreover, in the present specification, a “plan view” means a view in a direction perpendicular to a principal surface of the power-generating element or the power-generating layer unless otherwise stated such as a case where the term is used alone. Here, in a case of description of a “plan view of a certain surface” such as a “plan view of a side surface”, the term means a view from the front of the “certain surface”.

In the meantime, in the present specification, terms “above” and “below” do not represent an upward direction (vertically upward) and a downward direction (vertically downward) in light of absolute spatial recognition, but are used as terms to be defined depending on a relative positional relationship based on the order of lamination in a laminated structure. Moreover, the terms “above” and “below” are used not only in a case where two constituents are disposed with an interval therebetween and another constituent is present between these two constituents, but also in a case where two constituents are disposed close to each other and the two constituents are in contact with each other. In the following description, a negative side of the z axis will be referred to as “below” or a “lower side” while a positive side of the z axis will be referred to as “above” or an “upper side”.

Meanwhile, in the present specification, ordinal numbers such as “first” and “second” are not intended to represent the number or the order of the constituents but are used for the purpose of distinguishing the constituents while avoiding confusion of the constituents of the same type unless otherwise specifically stated.

### Embodiment 1

A configuration of a battery according to Embodiment 1 will be described to begin with.

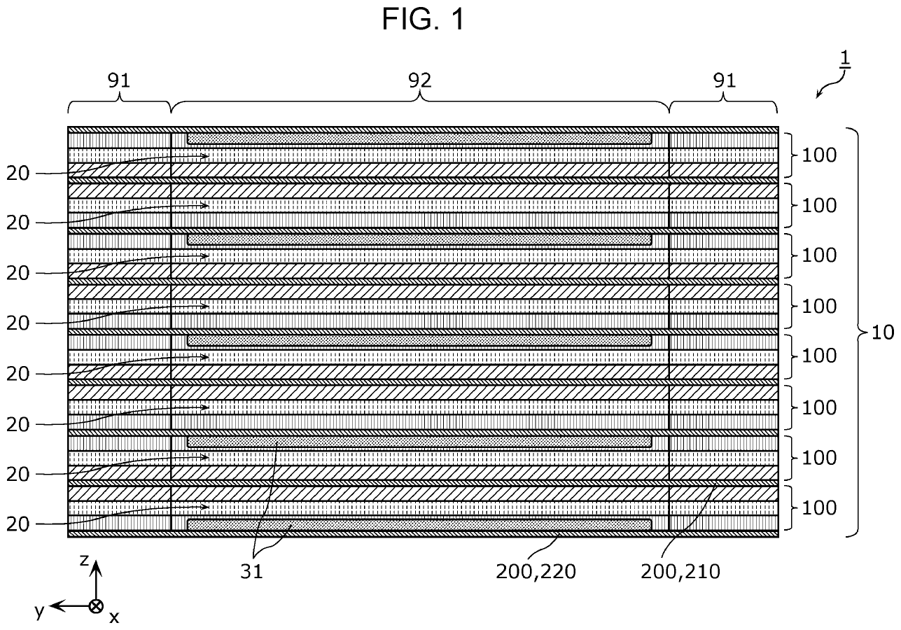

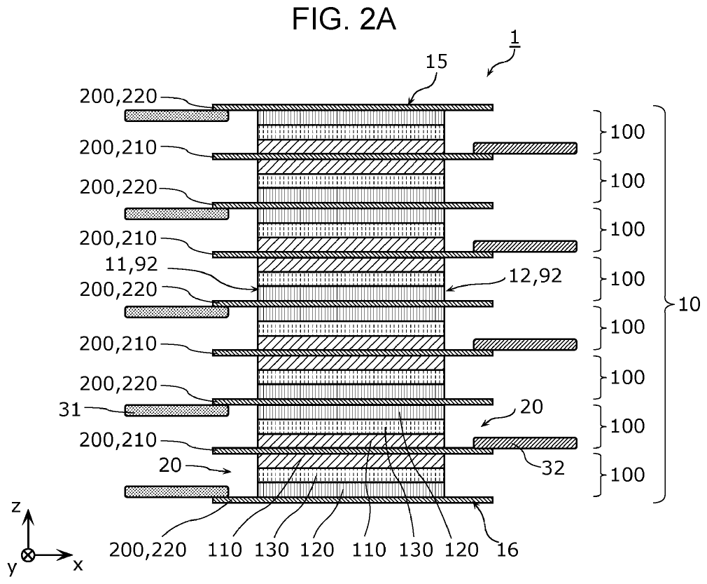

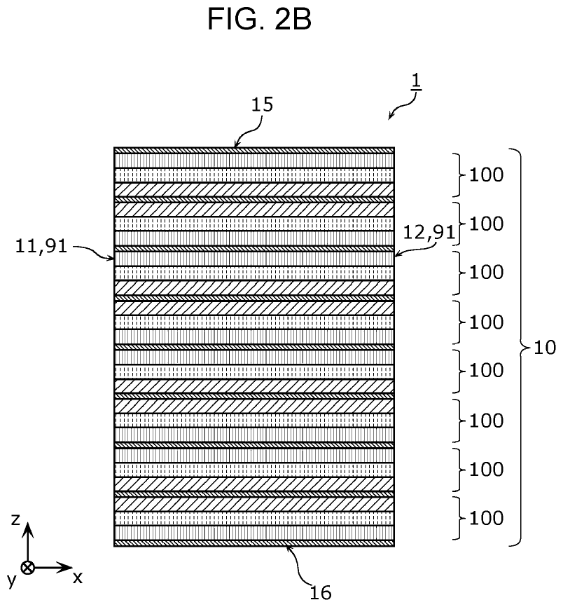

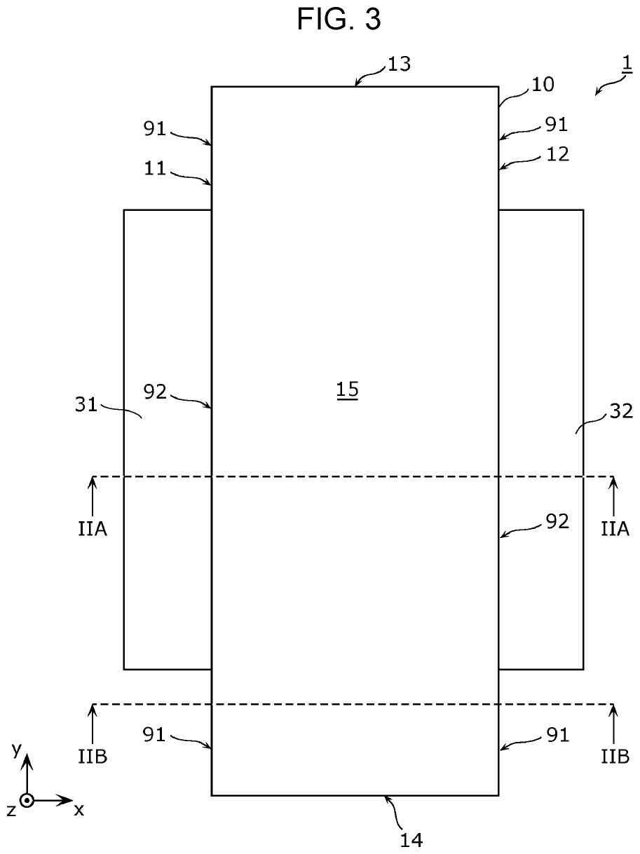

FIG. 1 is a side view of a battery according to Embodiment 1. FIG. 1 is a plan view when a side surface 11 to be described later is viewed from the front, or in other words, illustrating the side surface 11 in plan view. FIGS. 2A and 2B are sectional views of the battery according to the Embodiment 1. FIG. 2A is a sectional view at a position sectioning a receding region 92 to be described later. FIG. 2A represents a section taken along the IIA-IIA line in FIG. 3. Meanwhile, FIG. 2B is a sectional view at a position sectioning a continuous region 91 to be described later. FIG. 2B represents a section taken along the IIB-IIB line in FIG. 3. FIG. 3 is a top plan view of the battery according to the Embodiment 1. Note that side surfaces (end surfaces) of respective layers appearing on the side surface 11 in FIG. 1 are provided with the same shades as those of respective layers illustrated on the sections in FIGS. 2A and 2B. The same applies to respective side surfaces to be described later.

As illustrated in FIGS. 1 to 3, a battery 1 according to the present embodiment includes a power-generating element 10, counter electrode terminals 31, and electrode terminals 32. Each of the counter electrode terminals 31 and the electrode terminals 32 represents an example of a conductive member. The battery 1 is an all-solid-state battery, for example.

The power-generating element 10 has a structure in which power-generating layers 100 and current collectors 200 are laminated in a thickness direction of the power-generating layers 100.

As illustrated in FIG. 3, a shape in plan view of the power-generating element 10 is a rectangle, for example. In other words, the shape of the power-generating element 10 is a flat rectangular parallelepiped. Here, flatness means that a thickness (that is, a length in z-axis direction) is shorter than respective sides (that is, respective lengths in x-axis direction and y-axis direction) or a maximum width of a principal surface. The shape in plan view of the power-generating element 10 may be any of other polygons including a square, a hexagon, and an octagon, or may be any of a circle, an ellipse, and the like. It is to be noted that a thickness of each of layers is illustrated in an exaggerated manner in the drawings of the present specification including the side views as typified by FIG. 1 and the sectional views as typified by FIGS. 2A and 2B in order to clarify a layered structure of the power-generating element 10.

As illustrated in FIG. 3, the power-generating element 10 includes four side surfaces 11, 12, 13, and 14, and two principal surfaces 15 and 16.

The side surface 11 and the side surface 12 are back to back to each other and are parallel to each other. Each of the side surface 11 and the side surface 12 is a side surface that includes a long side of the principal surface 15.

The side surface 13 and the side surface 14 are back to back to each other and are parallel to each other. Each of the side surface 13 and the side surface 14 is a side surface that includes a short side of the principal surface 15.

The principal surface 15 and the principal surface 16 are back to back to each other and are parallel to each other. The principal surface 15 is the uppermost surface of the power-generating element 10. The principal surface 16 is the lowermost surface of the power-generating element 10. Each of the principal surface 15 and the principal surface 16 is a flat surface.

As illustrated in FIGS. 1 to 2B, the power-generating element 10 includes the power-generating layers 100 and the current collectors 200. Each power-generating layer 100 is a minimum structure of a power-generating unit of the battery, and is also referred to as a unit cell. In the meantime, there is also a case where the power-generating layer 100 and the current collector 200 coupled to the power-generating layer 100 are collectively referred to as a unit cell. The power-generating layers 100 are laminated so as to be electrically connected in parallel. In the present embodiment, the power-generating layers 100 are laminated such that all the power-generating layers 100 included in the power-generating element 10 are electrically connected in parallel. Although the number of the power-generating layers 100 included in the power-generating element 10 is eight layers in the illustrated example, the number of the power-generating layer 100 is not limited to the foregoing. For example, the number of the power-generating layers 100 included in the power-generating element 10 may be even layers such as two layers and four layers, or odd layers such as three layers and five layers.

Each of the power-generating layers 100 includes an electrode layer 110, a counter electrode layer 120, and a solid electrolyte layer 130. The electrode layer 110 and the counter electrode layer 120 each contain an active material, and are also referred to as an electrode active material layer and a counter electrode active material layer, respectively. In each of the power-generating layers 100, the electrode layer 110, the solid electrolyte layer 130, and the counter electrode layer 120 are laminated in this order along the z axis.

Here, the electrode layer 110 is one of a positive electrode layer and a negative electrode layer of the power-generating layer 100. The counter electrode layer 120 is the other one of the positive electrode layer and the negative electrode layer of the power-generating layer 100. In the following, a description will be given of a case where the electrode layer 110 is the negative electrode layer and the counter electrode layer 120 is the positive electrode layer as an example.

Configurations of the power-generating layers 100 are substantially the same as one another. Of two power-generating layers 100 adjacent to each other, the orders of arrangement of the respective layers constituting the power-generating layer 100 are opposite to each other. That is to say, the power-generating layers 100 are laminated in arrangement along the z axis while alternately reversing the orders of arrangement of the respective layers constituting the power-generating layers 100. In this way, the power-generating layers 100 are arranged so as to be electrically connected in parallel. In the present embodiment, the number of the power-generating layers 100 is even. Accordingly, the lowermost layer and the uppermost layer among the power-generating layers 100 are the layers having the same polarity.

Of the multiple power-generating layers 100, the two power-generating layers 100 adjacent to each other are laminated while interposing at least one current collector 200 out of the multiple current collectors 200 therebetween. Moreover, each power-generating layer 100 of the power-generating element 10 is sandwiched between two current collectors 200 located adjacent to each other among the multiple current collectors 200. In the illustrated example, every set of the power-generating layers 100 adjacent to each other among the multiple power-generating layers 100 are laminated while interposing the single current collector 200 therebetween. Instead, a set of the power-generating layers 100 may be laminated while interposing any of two and three or more current collectors 200 therebetween. When the power-generating layers 100 are laminated while interposing two current collectors 200 therebetween, the two current collectors 200 are boned to each other by using a conductive adhesive or a solder, or by means of direct welding, for example.

Each of the current collectors 200 includes an electrode current collector 210 that is electrically connected to the electrode layer 110, and a counter electrode current collector 220 that is electrically connected to the counter electrode layer 120. The electrode layer 110 is laminated on at least one of the principal surfaces of the electrode current collector 210 without interposing the solid electrolyte layer 130 therebetween. The counter electrode layer 120 is laminated on at least one of the principal surfaces of the counter electrode current collector 220 without interposing the solid electrolyte layer 130 therebetween.

Details of respective constituents included in the power-generating element 10 will be described.

The current collector 200 is a conductive member in any of a foil form, a plate form, and a mesh form. The current collector 200 may be a conductive thin film, for example. Examples of a material usable for constituting the current collector 200 include metals such as stainless steel (SUS), aluminum (Al), copper (Cu), and nickel (Ni). The electrode current collectors 210 and the counter electrode current collectors 220 in the current collectors 200 may be formed by using different materials.

A thickness of the current collector 200 is greater than or equal to 5 μm and less than or equal to 100 μm, for example. However, the thickness is not limited to this range.

The electrode layer 110 is in contact with the principal surface of the electrode current collector 210. Here, the electrode current collector 210 may include a current collector layer which is a layer being provided at a portion in contact with the electrode layer 110 and containing the conductive material. The counter electrode layer 120 is in contact with the principal surface of the counter electrode current collector 220.

Meanwhile, the counter electrode current collector 220 may include a current collector layer which is a layer being provided at a portion in contact with the counter electrode layer 120 and including the conductive material.

The electrode layer 110 is disposed on the principal surface on the counter electrode layer 120 side of the electrode current collector 210. The electrode layer 110 includes a negative electrode active material as an electrode material, for example. The electrode layer 110 is disposed opposite to the counter electrode layer 120.

A negative electrode active material such as graphite and metallic lithium can be used as the negative electrode active material to be contained in the electrode layer 110, for example. Various materials that can extract and insert ions as typified by lithium (Li) and magnesium (Mg) can be used as the material of the negative electrode active material.

Meanwhile, a solid electrolyte such as an inorganic solid electrolyte may be used as a material contained in the electrode layer 110, for example. A sulfide solid electrolyte, an oxide solid electrode, and the like can be used as the inorganic solid electrolyte, for example. A mixture of lithium sulfide (Li₂S) and phosphorus pentasulfide (P₂S₅) can be used as the sulfide solid electrolyte, for example. In the meantime, a conducting agent such as acetylene black or a binder such as polyvinylidene fluoride may be used as the material contained in the electrode layer 110.

The electrode layer 110 is fabricated by applying a coating material in the form of a paste, which is prepared by kneading the materials contained in the electrode layer 110 together with a solvent, onto the principal surface of the electrode current collector 210 and drying the coating material. In order to increase a density of the electrode layer 110, the electrode current collector 210 coated with the electrode layer 110 (also referred to as an electrode plate) may be pressed after a drying process. A thickness of the electrode layer 110 is greater than or equal to 5 μm and less than or equal to 300 μm, for example. However, the thickness is not limited to this range.

The counter electrode layer 120 is disposed on the principal surface on the electrode layer 110 side of the counter electrode current collector 220. The counter electrode layer 120 is a layer including a positive electrode material such as an active material, for example. The positive electrode material is a material constituting a counter electrode to the negative electrode material. The counter electrode layer 120 contains a positive electrode active material, for example.

A positive electrode active material such as lithium cobaltate composite oxide (LCO), lithium nickelate composite oxide (LNO), lithium manganate composite oxide (LMO), lithium-manganese-nickel composite oxide (LMNO), lithium-manganese-cobalt composite oxide (LMCO), lithium-nickel-cobalt composite oxide (LNCO), and lithium-nickel-manganese-cobalt composite oxide (LNMCO) can be used as the positive electrode active material contained in the counter electrode layer 120, for example. Various materials that can extract and insert ions such as Li and Mg can be used as the material of the positive electrode active material.

Meanwhile, a solid electrolyte such as an inorganic solid electrolyte may be used as a material contained in the counter electrode layer 120, for example. A sulfide solid electrolyte, an oxide solid electrode, and the like can be used as the inorganic solid electrolyte. A mixture of Li₂S and P₂S₅ can be used as the sulfide solid electrolyte, for example. A surface of the positive electrode active material may be coated with a solid electrolyte. In the meantime, a conducting agent such as acetylene black or a binder such as polyvinylidene fluoride may be used as the material contained in the counter electrode layer 120.

The counter electrode layer 120 is fabricated by applying a coating material in the form of a paste, which is prepared by kneading the materials contained in the counter electrode layer 120 together with a solvent, onto the principal surface of the counter electrode current collector 220 and drying the coating material. In order to increase a density of the counter electrode layer 120, the counter electrode current collector 220 coated with the counter electrode layer 120 (also referred to as a counter electrode plate) may be pressed after a drying process. A thickness of the counter electrode layer 120 is greater than or equal to 5 μm and less than or equal to 300 μm, for example. However, the thickness is not limited to this range.

The solid electrolyte layer 130 is disposed between the electrode layer 110 and the counter electrode layer 120. The solid electrolyte layer 130 is contact with the electrode layer 110 and with the counter electrode layer 120, respectively. The solid electrolyte layer 130 is a layer including an electrolyte material. Publicly known electrolytes designed for batteries can be used as such an electrolyte material. A thickness of the solid electrolyte layer 130 may be greater than or equal to 5 μm and less than or equal to 300 μm, or may be greater than or equal to 5 μm and less than or equal to 100 μm.

The solid electrolyte layer 130 contains a solid electrolyte. A solid electrolyte such as an inorganic solid electrolyte can be used as this solid electrode, for example. A sulfide solid electrolyte, an oxide solid electrode, and the like can be used as the inorganic solid electrolyte. A mixture of Li₂S and P₂S₅ can be used as the sulfide solid electrolyte, for example. Here, the solid electrolyte layer 130 may contain a binder such as polyvinylidene fluoride in addition to the electrolyte material.

In the present embodiment, the electrode layer 110, the counter electrode layer 120, and the solid electrolyte layer 130 are maintained in a state of parallel flat plates. In this way, it is possible to suppress the occurrence of cracks or collapse due to flexure. Here, the electrode layer 110, the counter electrode layer 120, and the solid electrolyte layer 130 may be integrated and gently curved together.

Meanwhile, in the power-generating layer 100, respective shapes and sizes of the electrode layer 110, the solid electrolyte layer 130, and the counter electrode layer 120 are the same and contours of the respective layers coincide with one another, for example.

Moreover, in the power-generating element 10 of the present embodiment, an end surface on the side surface 11 side of the counter electrode current collector 220 and an end surface on the side surface 11 side of the electrode current collector 210 coincide with each other when viewed in the z-axis direction. The same applies to respective end surface on the side surface 12 side of the counter electrode current collector 220 and the electrode current collector 210. In the power-generating element 10, respective shapes and sizes of the current collectors 200 are the same and respective contours thereof coincide with one another.

Each of the side surface 11 and the side surface 12 includes the continuous region 91 and the receding region 92. The continuous region 91 is an example of a first region. The receding region 92 is an example of a second region.

The continuous regions 91 are regions of the side surface 11 and the side surface 12 where the respective power-generating layers 100 of the current collectors 200 do not recede from the current collectors 200 that are adjacent to the respective power-generating layers 100. In other words, when focusing on a certain one of the power-generating layers 100, the certain one power-generating layer 100 does not recede from the current collectors 200 adjacent to the certain one power-generating layer 100 in the continuous region 91. When the continuous regions 91 are viewed in the z-axis direction, for example, the respective side surfaces of the power-generating layers 100, namely, the respective side surfaces of the electrode layers 110, the solid electrolyte layers 130, and the counter electrode layers 120 in the power-generating layers 100 coincide with the respective side surfaces of the current collectors 200. In the continuous regions 91, the respective side surfaces of the power-generating layers 100 and the respective side surfaces of the current collectors 200 are continuous and flush with one another, thereby forming a flat surface.

Meanwhile, the continuous regions 91 are regions including end portions of the side surface 11 and the side surface 12 in the direction perpendicular to the direction of lamination of the power-generating element 10. Thus, each power-generating layer 100 is disposed between the current collectors 200 that are adjacent to each other at a ridge line portion of the power-generating element 10, thereby keeping the current collectors 200 from coming into contact with each other at the ridge line portion of the power-generating element 10 where an influence of an external force is large.

The receding region 92 is a region where recesses 20 are formed on the side surface 11 and the side surface 12 by causing the respective power-generating layers 100 recede from the current collectors 200 that are adjacent to the respective power-generating layers 100 among the multiple current collectors 200. In other words, in the receding region 92, when focusing on a certain one of the power-generating layers 100, the certain one power-generating layer 100 recedes from the current collectors 200 adjacent to the certain one power-generating layer 100. In the receding region 92, the recesses 20 are formed by causing the respective power-generating layers 100 to recede from the current collectors 200. To be more precise, each power-generating layer 100 recedes from the electrode current collector 210 and the counter electrode current collector 220 which are adjacent to both sides of the power-generating layer 100 in the direction of lamination. When the receding region 92 is viewed in the z-axis direction, for example, the respective side surfaces of the power-generating layers 100 are each located on an inner side relative to the respective side surfaces of the current collectors 200. That is to say, in the receding region 92, the respective current collectors 200 project from the respective power-generating layers 100. To be more precise, the electrode current collector 210 and the counter electrode current collector 220 which are adjacent to both sides of the power-generating layer 100 in the direction of lamination project from the power-generating layer 100, respectively.

Meanwhile, in the receding region 92, the recesses 20 formed by the recession of the respective power-generating layers 100 are arranged in the direction of lamination (the z-axis direction) of the power-generating element 10. In this way, it is easier to form the receding region 92.

In the meantime, regarding the side surface 11 and the side surface 12, or in other words, in plan view of the side surface 11 and the side surface 12, the continuous regions 91 and the receding region 92 are adjacent to one another in the direction perpendicular to the direction of lamination of the power-generating element 10. Moreover, regarding the side surface 11 and the side surface 12, the continuous regions 91 are located so as to sandwich a receding region 92 from both sides in the direction perpendicular to the direction of lamination of the power-generating element 10. In other words, the receding region 92 is disposed so as to separate the continuous regions 91 from each other. As a consequence, each recess 20 is a space surrounded by the power-generating layer 100 in the continuous region 91 and the current collectors 200 in the receding region 92.

Meanwhile, regarding the side surface 11 and the side surface 12, a length of the receding region 92 in the direction perpendicular to the direction of lamination of the power-generating element 10 is larger than a length of each continuous region 91 in the direction perpendicular to the direction of lamination of the power-generating element 10. This configuration makes it possible to increase a connection area between the current collector 200 and a terminal in the receding region 92, so that the large-current characteristics of the battery 1 can be enhanced. In the following description, the length of each of the continuous region 91 and the receding region 92 in the direction perpendicular to the direction of lamination may be referred to as a “width” when appropriate. Here, in the case of separation of the continuous region 91 and/or receding region 92 on the side surface 11 and the side surface 12, the width of each of the continuous regions 91 and/or receding regions 92 is equivalent to a sum of widths of the separated continuous regions 91 and/or receding regions 92.

In each recess 20, principal surfaces on the recess 20 side of the current collectors 200 that are adjacent to the corresponding receding power-generating layer 100 are exposed, for example. Accordingly, it is possible to electrically connect the counter electrode terminal 31 or the electrode terminal 32 in the recess 20. Here, any of the principal surfaces on the recess 20 side of the current collectors 200 may be coated with the electrode layer 110 or the counter electrode layer 120. The thickness of the electrode layer 110 or the counter electrode layer 120 in this case is less than or equal to one-fifth of the thickness of the electrode layer 110 or the counter electrode layer 120 at a portion not provided with the recess 20.

Each recess 20 is a recess having a stepped shape, for example. However, the shape of the recess 20 is not limited thereto. The recess 20 may be a recess having a tapered shape or a recess having a curved surface.

A maximum depth of the recess 20 is larger than the thickness of the corresponding power-generating layer 100, or in other words, a width of the recess 20 in the direction of lamination. Accordingly, it is possible to increase the connection area between either the counter electrode terminal 31 or the electrode terminal 32 and the current collector 200 in the case where the counter electrode terminal 31 or the electrode terminal 32 is connected to the current collector 200 inside the recess 20, thereby enhancing the large-current characteristics.

In the meantime, the maximum depth of the recess 20 may be greater than or equal to 4.5 times of the thickness of the current collector 200 adjacent to the recess 20. In this way, when both top and bottom principal surfaces and the side surface of the current collector 200 are connected to the terminal, this configuration makes it possible to secure the contact area that is greater than or equal to 10 times as compared to that in the case where only the side surface portion of the current collector 200 is connected to the terminal. Alternatively, the maximum depth of the recess 20 may be greater than or equal to 9 times of the thickness of the current collector 200 adjacent to the recess 20. When one of the principal surfaces and the side surface of the current collector 200 are connected to the terminal, this configuration makes it possible to secure the contact area that is greater than or equal to 10 times as compared to that in the case where only the side surface portion of the current collector 200 is connected to the terminal.

Here, the side surface 13 and the side surface 14 are each formed only from the continuous region 91 without including the receding region 92, for example. However, without limitation to the foregoing, the side surface 13 and the side surface 14 may each include the continuous region 91 and the receding region 92. In the meantime, the structures of the side surface 11 and the side surface 12 are not limited to the case of being formed on the side surface 11 and the side surface 12 in the back-to-back positional relationship. For example, instead of the side surface 11 and the side surface 12, the structures of the side surface 11 and the side surface 12 may be formed on two side surfaces such as the side surface 11 and the side surface 13 having a relationship of being adjacent (orthogonal) to each other.

In the receding region 92, the counter electrode terminals 31 and the electrode terminals 32 each cover the principal surfaces of the current collectors 200 being adjacent to the respective power-generating layers 100 and are electrically connected to the principal surfaces of the current collectors 200. The counter electrode terminals 31 and the electrode terminals 32 are in contact with the principal surfaces of the current collectors 200, for example. To be more precise, in the receding region 92 on the side surface 11, each counter electrode terminal 31 covers the principal surface on the recess 20 side of the counter electrode current collector 220 being adjacent to and projecting from the recess 20, and is electrically connected to the counter electrode current collector 220. In the receding region 92 on the side surface 12, each electrode terminal 32 covers the principal surface on the recess 20 side of the electrode current collector 210 being adjacent to and projecting from the recess 20, and is electrically connected to the electrode current collector 210. Accordingly, the counter electrode terminal 31 functions as an extraction electrode for the counter electrode layer 120 while the electrode terminal 32 functions as an extraction electrode for the electrode layer 110. It is possible to establish parallel connection of the entire battery 1 by connecting the respective counter electrode terminals 31 in a lump and connecting the respective electrode terminals 32 in a lump. Here, the counter electrode terminal 31 may be connected to either the top principal surface or the bottom principal surface of the counter electrode current collector 220. Meanwhile, the electrode terminal 32 may be connected to either the top principal surface or the bottom principal surface of the electrode current collector 210. It is possible to increase the connection area between the counter electrode terminal 31 and the counter electrode current collector 220 and the connection area between the electrode terminal 32 and the electrode current collector 210 by connecting the counter electrode terminal 31 and the electrode terminal 32 to the receding region 92 on the different side surfaces.

The counter electrode terminal 31 is disposed inside the recess 20 and away from the side surface of the power-generating layer 100. Here, the counter electrode terminal 31 may be in contact with the counter electrode layer 120 or in contact with the counter electrode layer 120 and the solid electrolyte layer 130 as long as the counter electrode terminal 31 is not in contact with the electrode layer 110 in the power-generating layer 100.

The electrode terminal 32 is disposed inside the recess 20 and away from the side surface of the power-generating layer 100. Here, the electrode terminal 32 may be in contact with the electrode layer 110 or in contact with the electrode layer 110 and the solid electrolyte layer 130 as long as the electrode terminal 32 is not in contact with the counter electrode layer 120 in the power-generating layer 100.

In the meantime, the counter electrode terminal 31 and the electrode terminal 32 are not connected to the principal surface 15 and the principal surface 16 of the power-generating element 10, for example. Nonetheless, the counter electrode terminal 31 and the electrode terminal 32 may be connected to the principal surface 15 and the principal surface 16 instead.

Each of the counter electrode terminals 31 and the electrode terminals 32 is a lead in the form of a foil which is made of a metal such as nickel, stainless steel, aluminum, and copper. A method of connecting the counter electrode terminals 31 and the electrode terminals 32 to the current collectors 200 is not limited to a particular method. It is possible to adopt a method such as adhesion and welding, for example. In the case of adhesion, the adhesion is established by using a conductive adhesive agent, a conductive adhesion tape, and the like. The counter electrode terminals 31 and the electrode terminals 32 are formed by using the same material. Instead, the counter electrode terminals 31 may be formed by using a different material from that of the electrode terminals 32.

As described above, in the battery 1, the side surface 11 and the side surface 12 each include the continuous regions 91 and the receding region 92. Hence, in the receding region 92, the terminal (such as the counter electrode terminal 31 and the electrode terminal 32) for extracting an electric current can be connected to the principal surface on the recess 20 side of each current collector 200. Thus, the connection area between the terminal and the current collector 200 can be increased and resistance at a connecting portion can be reduced as compared to the case of connecting the terminal to the side surface of the current collector 200. Accordingly, it is possible to enhance the large-current characteristics. Meanwhile, the increase in connection area between the terminal and the current collector 200 enhances a mechanical connection strength between the terminal and the current collector 200, so that reliability of the battery 1 can be improved.

In the meantime, in the receding region 92, the current collector 200 projects from the side surface of the power-generating layer 100. On the other hand, in each continuous region 91, the current collectors 200 and the power-generating layers 100 each including the electrode layer 110, the counter electrode layer 120, and the solid electrolyte layer 130 are disposed and laminated in alignment of the positions of the side surfaces thereof at a position of tip ends of the current collectors 200 projecting in the receding region 92. Usually, when the current collector 200 projects, a projecting portion of the current collector 200 is prone to deformation while moving in the direction of lamination. However, the current collector 200 projecting in the receding region 92 is supported by the power-generating layer 100 in the adjacent continuous region 91 and is less likely to move. Thus, an interval of the current collectors 200 tends to be kept constant. Accordingly, the current collectors 200 are kept from coming into contact with each other to cause a short circuit or from coming close to each other to cause a short circuit discharge in the process of manufacturing the battery 1 and when the battery 1 is in use. Thus, reliability can be improved. Particularly, since the receding region 92 is sandwiched between the continuous regions 91 from two sides, the current collectors 200 in the receding region 92 are supported by the power-generating layers 100 in the continuous regions 91 on both sides. As a consequence, each current collector 200 is apt to be strained and the interval of the current collectors 200 in the receding region 92 is maintained more appropriately. Meanwhile, on the side surface 11 and the side surface 12, the power-generating layer 100 recedes only in the receding region 92 out of the continuous regions 91 and the receding region 92. Thus, it is possible to reduce the region of recession of the power-generating layer 100 and to increase an energy density.

### Modified Example 1

Next, Modified Example 1 of the Embodiment 1 will be described. Note that the following description of the Modified Example 1 will be focused on different features from the Embodiment 1 while omitting or simplifying explanations of features in common. The same applies to other modified examples from Modified Example 2 on to be described later. The description of the respective modified examples will be focused on different features from the Embodiment 1 and other modified examples while omitting or simplifying explanations of features in common.

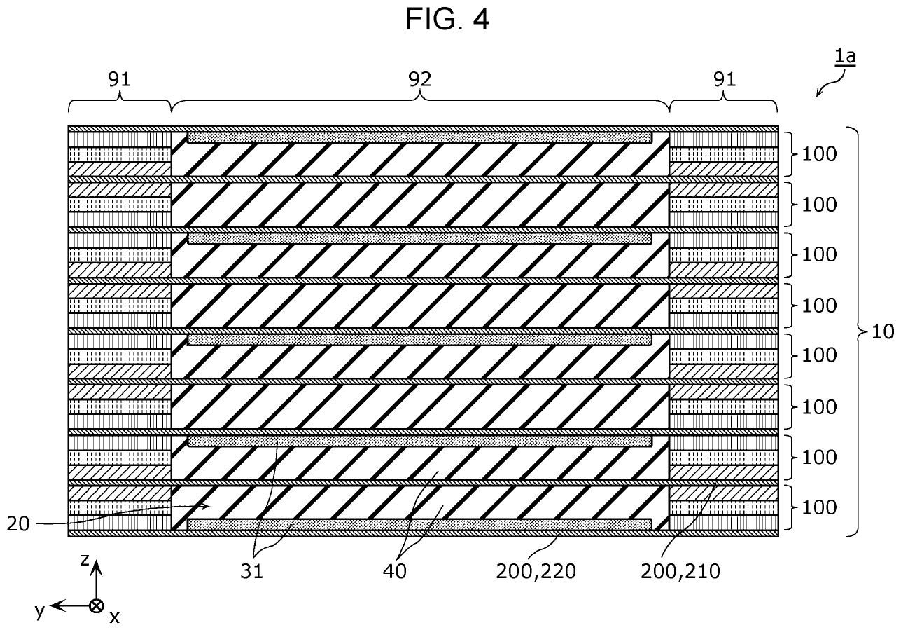

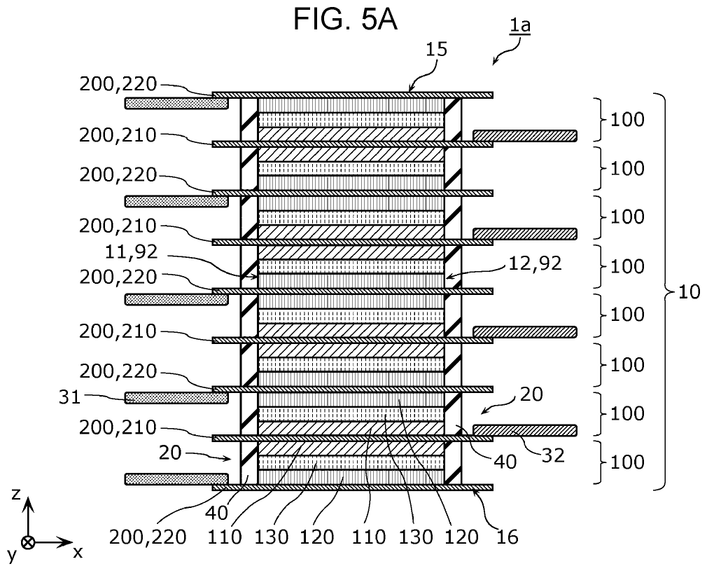

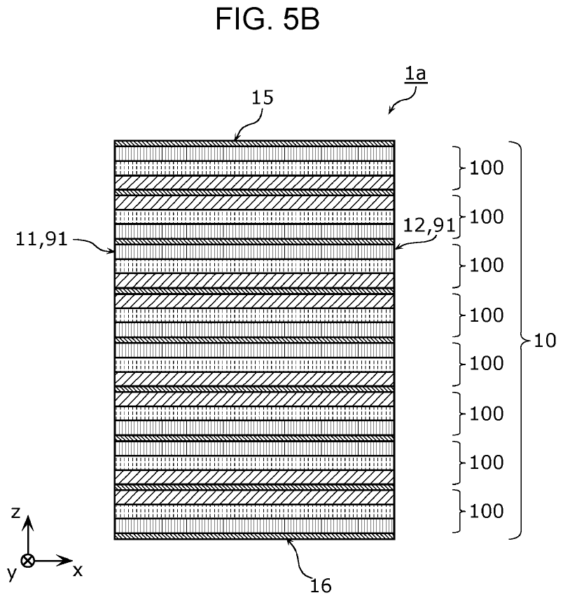

FIG. 4 is a side view of a battery according to the Modified Example 1 of the Embodiment 1. FIG. 4 is a plan view in the case of viewing the side surface 11 from the front. FIGS. 5A and 5B are sectional views of the battery according to the Modified Example 1 of the Embodiment 1. FIG. 5A is a sectional view at a position sectioning the receding region 92 as with FIG. 2A. Meanwhile, FIG. 5B is a sectional view at a position sectioning the continuous region 91 as with FIG. 2B.

As illustrated in FIGS. 4 to 5B, a battery 1a according to the present modified example is different from the battery 1 according to the Embodiment 1 in that the battery 1a further includes insulating members 40.

Each insulating member 40 covers at least part of each power-generating layer 100 in the receding region 92 and is in contact with the side surface of the power-generating layer 100. The insulating member 40 is an insulating layer having an insulation property, for example. In the battery 1a, the insulating member 40 is located inside the recess 20 in the receding region 92 and completely covers the side surface of each power-generating layer 100. In other words, in the recess 20, the side surface of the power-generating layer 100 is not exposed. In the receding region 92, the insulating member 40 covers the side surfaces of the electrode layer 110, the solid electrolyte layer 130, and the counter electrode layer 120 in a lump. Since the insulating member 40 covers the side surface of the power-generating layer 100 as described above, it is possible to suppress collapse of the materials on the side surfaces of the electrode layer 110, the solid electrolyte layer 130, and the counter electrode layer 120 as well as the occurrence of a short circuit.

Meanwhile, in the receding region 92, the insulating member 40 covers part of the principal surfaces of the current collectors 200 that are adjacent to the recess 20. Specifically, in the recess 20, the insulating member 40 continuously covers the side surface of the power-generating layer 100 and the principal surfaces of the current collectors 200, and is in contact with the side surface of the power-generating layer 100 and the principal surfaces of the current collectors 200.

The insulating member 40 is formed by using an insulating material having an electrically insulating property. The insulating member 40 is formed, for example, by coating an insulating paste containing the insulating material, for example. The insulating member 40 contains a resin, for instance. The insulating member 40 containing the resin makes it possible to increase shock resistance of the battery 1a and to relax a stress to be applied to the battery 1a in association with expansion and contraction of the battery 1a due to a change in temperature and at the time of charge and discharge.

The resin is an epoxy-based resin, for example. However, the resin is not limited thereto. Here, an inorganic material may be used as the insulating material. The insulating material usable therein is selected based on various characteristics including flexibility, gas barrier properties, shock resistance, heat resistance, and the like.

The counter electrode terminal 31 and the electrode terminal 32 are disposed in the recess 20 and away from the insulating member 40, respectively. Nonetheless, at least one of the counter electrode terminal 31 and the electrode terminal 32 may be in contact with the insulating member 40.

### Modified Example 2

Next, Modified Example 2 of the Embodiment 1 will be described.

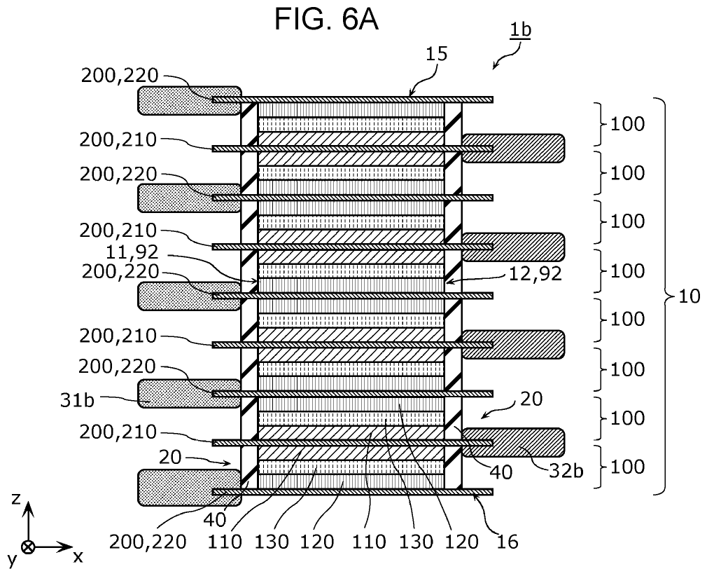

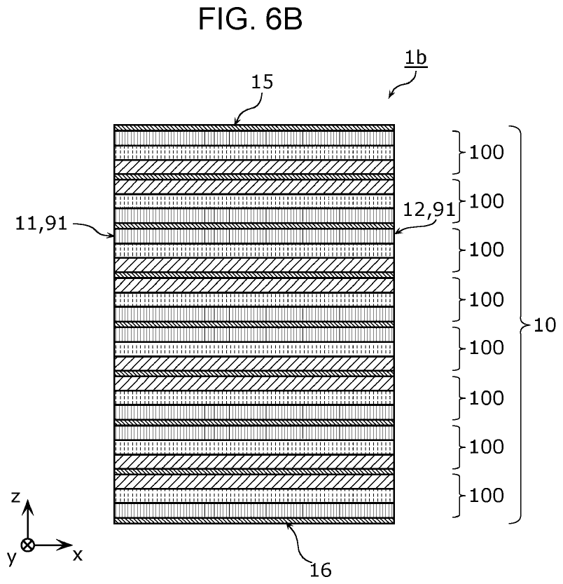

FIGS. 6A and 6B are sectional views of a battery according to the Modified Example 2 of the Embodiment 1. FIG. 6A is a sectional view at a position sectioning the receding region 92 as with FIG. 2A. Meanwhile, FIG. 6B is a sectional view at a position sectioning the continuous region 91 as with FIG. 2B.

As illustrated in FIGS. 6A and 6B, in comparison with the battery 1a according to the Modified Example 1 of the Embodiment 1, a battery 1b according to the present modified example is different in that the battery 1b includes counter electrode terminals 31b and electrode terminals 32b each representing an example of the conductive member instead of the counter electrode terminals 31 and the electrode terminals 32. Each of the counter electrode terminals 31b and the electrode terminals 32b has a different location of contact with the power-generating element 10 as compared to the counter electrode terminal 31 and the electrode terminal 32.

In the receding region 92 on the side surface 11, each counter electrode terminal 31b covers principal surfaces on both sides of the counter electrode current collector 220 projecting adjacent to the recess 20, and is electrically connected to the principal surfaces on both sides of the counter electrode current collector 220. The counter electrode terminal 31b also covers a side surface of the counter electrode current collector 220 projecting adjacent to the recess 20. The counter electrode terminal 31b continuously covers the one principal surface, the side surface, and the other principal surface of the counter electrode current collector 220 projecting adjacent to the recess 20. The counter electrode terminal 31b is in contact with the principal surfaces on both sides and the side surface of the counter electrode current collector 220 projecting adjacent to the recess 20, for example. Moreover, the counter electrode terminal 31b is in contact with the insulating member 40 that covers the side surface of the power-generating layer 100 inside the recess 20, and is located away from the power-generating layer 100 while interposing the insulating member 40 therebetween.

In the receding region 92 on the side surface 12, each electrode terminal 32b covers principal surfaces on both sides of the electrode current collector 210 projecting adjacent to the recess 20, and is electrically connected to the principal surfaces on both sides of the electrode current collector 210. The electrode terminal 32b also covers a side surface of the electrode current collector 210 projecting adjacent to the recess 20. The electrode terminal 32b continuously covers the one principal surface, the side surface, and the other principal surface of the electrode current collector 210 projecting adjacent to the recess 20. The electrode terminal 32b is in contact with the principal surfaces on both sides and the side surface of the electrode current collector 210 projecting adjacent to the recess 20, for example. Moreover, the electrode terminal 32b is in contact with the insulating member 40 that covers the side surface of the power-generating layer 100 inside the recess 20, and is located away from the power-generating layer 100 while interposing the insulating member 40 therebetween.

As described above, in the battery 1b, each terminal for extracting the electric current is electrically connected to the principal surfaces on both sides of the current collector 200 projecting in the receding region 92, so that the connection area between the terminal and the current collector 200 can be increased. This makes it possible to enhance the large-current characteristics and to enhance the mechanical connection strength between the terminal and the current collector, thereby improving reliability.

### Modified Example 3

Next, Modified Example 3 of the Embodiment 1 will be described.

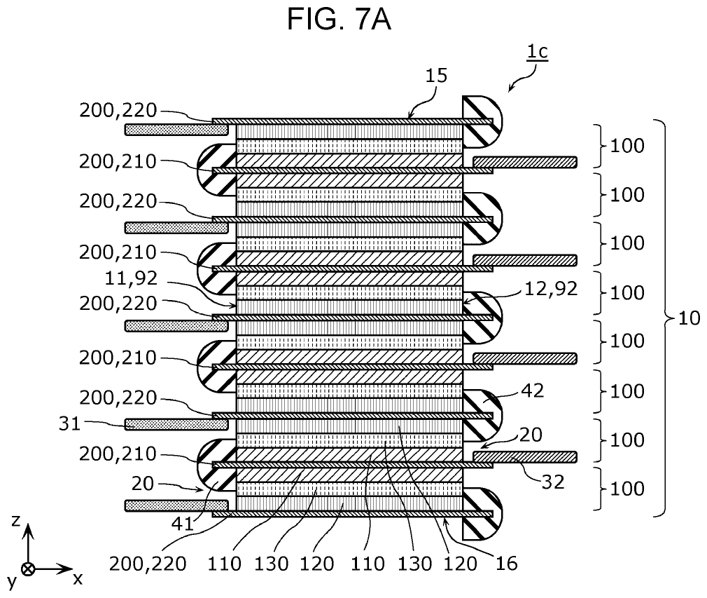

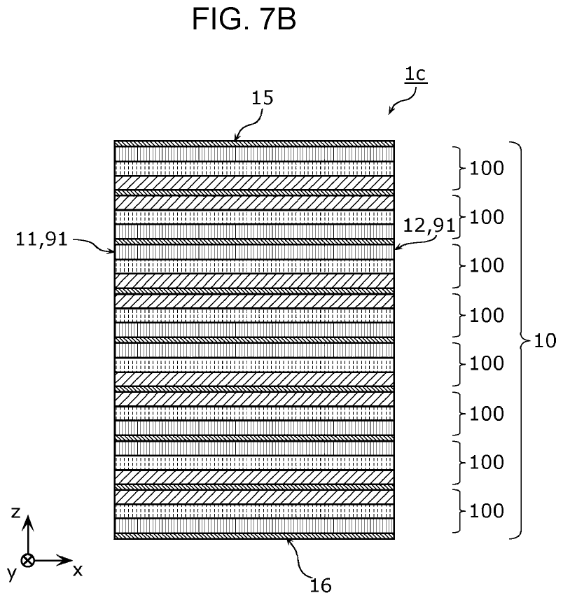

FIGS. 7A and 7B are sectional views of a battery according to the Modified Example 3 of the Embodiment 1. FIG. 7A is a sectional view at a position sectioning the receding region 92 as with FIG. 2A. Meanwhile, FIG. 7B is a sectional view at a position sectioning the continuous region 91 as with FIG. 2B.

As illustrated in FIGS. 7A and 7B, in comparison with the battery 1 according to the Embodiment 1, a battery 1c according to the present modified example is different in that the battery 1c further includes electrode insulating members 41 and counter electrode insulating members 42 each representing an example of an insulating member.

Each of the electrode insulating members 41 and the counter electrode insulating members 42 has a different location of contact with the power-generating element 10 as compared to the above-described insulating member 40.

In the receding region 92 on the side surface 11, the electrode insulating members 41 cover the electrode current collectors 210 and the electrode layers 110, and are in contact with the electrode current collectors 210 and the electrode layers 110. Specifically, in the receding region 92 on the side surface 11, the electrode insulating members 41 cover the electrode layers 110 of the respective power-generating layers 100 and the respective electrode current collectors 210 included in the current collectors 200. In the receding region 92 on the side surface 11, each electrode insulating member 41 covers the principal surfaces on both sides and the side surface of the electrode current collector 210 projecting adjacent to the recess 20. The electrode insulating member 41 continuously covers the electrode current collector 210 and one or two electrode layers 110 adjacent to the electrode current collector 210. The electrode insulating member 41 is not in contact with the counter electrode current collector 220, for example. The electrode insulating member 41 completely covers the electrode current collector 210 and the electrode layer 110 in the recess 20, for example. In other words, in the recess 20, the electrode current collector 210 and the electrode layer 110 are not exposed. Here, part of the electrode current collector 210 and the electrode layer 110 may be exposed in the recess 20.

Meanwhile, in the receding region 92 on the side surface 11, the electrode insulating members 41 cover at least part of the solid electrolyte layers 130. Accordingly, each electrode insulating member 41 continuously covers a range from at least part of the solid electrolyte layer 130 of one power-generating layer 100 to at least part of the solid electrolyte layer 130 of another power-generating layer 100 out of the two adjacent power-generating layers 100. As a consequence, a possibility of exposure of the electrode layers 110 is reduced even when the widths (the lengths in the z-axis direction) of the electrode insulating members 41 vary due to manufacturing tolerances. This configuration suppresses a short circuit due to the counter electrode terminal 31 coming into contact with the electrode current collector 210 and the electrode layer 110. Meanwhile, very fine asperities are present on the side surface of the solid electrolyte layer 130 made of a powder material. For this reason, penetration of the electrode insulating member 41 into the asperities enhances an adhesion strength of the electrode insulating member 41, whereby insulation reliability is improved. Here, in the receding region 92 on the side surface 11, the electrode insulating member 41 may further cover at least part of the counter electrode layer 120. In the meantime, the electrode insulating member 41 has a stripe shape in plan view of the side surface 11.

In the receding region 92 on the side surface 12, the counter electrode insulating members 42 cover the counter electrode current collectors 220 and the counter electrode layers 120, and are in contact with the counter electrode current collectors 220 and the counter electrode layers 120. Specifically, in the receding region 92 on the side surface 12, the counter electrode insulating members 42 cover the counter electrode layers 120 of the respective power-generating layers 100 and the respective counter electrode current collectors 220 included in the current collectors 200. In the receding region 92 on the side surface 12, each counter electrode insulating member 42 covers the principal surfaces on both sides and the side surface of the counter electrode current collector 220 projecting adjacent to the recess 20. The counter electrode insulating member 42 continuously covers the counter electrode current collector 220 and one or two counter electrode layers 120 adjacent to the counter electrode current collector 220. The counter electrode insulating member 42 is not in contact with the electrode current collector 210, for example. The counter electrode insulating member 42 completely covers the counter electrode current collector 220 and the counter electrode layer 120 in the recess 20, for example. In other words, in the recess 20, the counter electrode current collector 220 and the counter electrode layer 120 are not exposed. Here, part of the counter electrode current collector 220 and the counter electrode layer 120 may be exposed in the recess 20.

Meanwhile, in the receding region 92 on the side surface 12, the counter electrode insulating members 42 cover at least part of the solid electrolyte layers 130. Accordingly, each counter electrode insulating member 42 continuously covers a range from at least part of the solid electrolyte layer 130 of one power-generating layer 100 to at least part of the solid electrolyte layer 130 of another power-generating layer 100 out of the two adjacent power-generating layers 100. As a consequence, the same effects as those in the case of causing the electrode insulating member 41 to cover the solid electrolyte layer 130 are available. Here, in the receding region 92 on the side surface 12, the counter electrode insulating member 42 may further cover at least part of the electrode layer 110. In the meantime, the counter electrode insulating member 42 has a stripe shape in plan view of the side surface 12.

As described above, in the battery 1c, the electrode current collector 210 and the electrode layer 110 are covered with the electrode insulating member 41 in the receding region 92 on the side surface 11 where the counter electrode terminal 31 is connected to the counter electrode current collector 220, thereby keeping the counter electrode terminal 31 from coming into contact with the electrode current collector 210 and the electrode layer 110 and causing a short circuit. Moreover, in the battery 1c, the counter electrode current collector 220 and the counter electrode layer 120 are covered with the counter electrode insulating member 42 in the receding region 92 on the side surface 12 where the electrode terminal 32 is connected to the electrode current collector 210, thereby keeping the electrode terminal 32 from coming into contact with the counter electrode current collector 220 and the counter electrode layer 120 and causing a short circuit. Thus, reliability of the battery 1c is improved.

### Modified Example 4

Next, Modified Example 4 of the Embodiment 1 will be described.

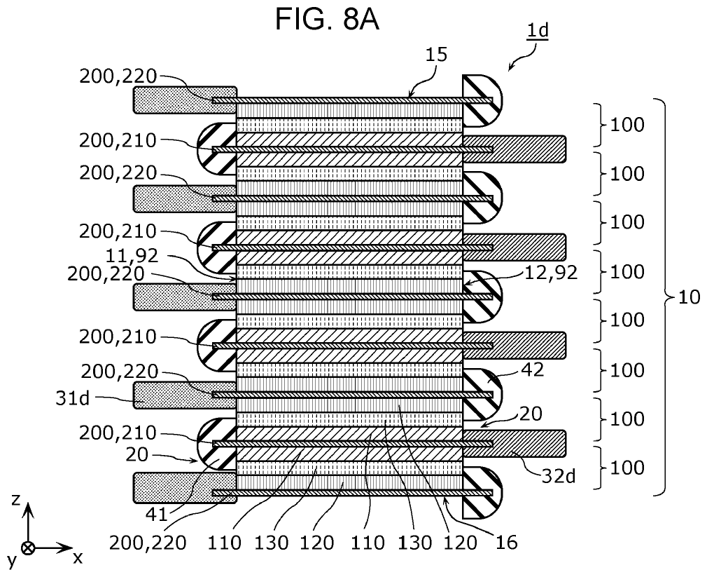

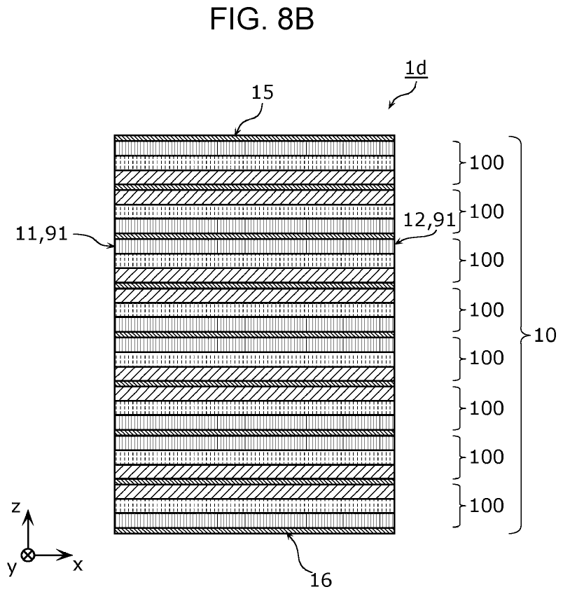

FIGS. 8A and 8B are sectional views of a battery according to the Modified Example 4 of the Embodiment 1. FIG. 8A is a sectional view at a position sectioning the receding region 92 as with FIG. 2A. Meanwhile, FIG. 8B is a sectional view at a position sectioning the continuous region 91 as with FIG. 2B.

As illustrated in FIGS. 8A and 8B, in comparison with the battery 1c according to the Modified Example 3 of the Embodiment 1, a battery 1d according to the present modified example is different in that the battery 1d includes counter electrode terminals 31d and electrode terminals 32d each representing an example of the conductive member instead of the counter electrode terminals 31 and the electrode terminals 32.

Each of the counter electrode terminals 31d and the electrode terminals 32d adopts a different layout mode as compared to the counter electrode terminals 31 and the electrode terminals 32.

In the receding region 92 on the side surface 11, each counter electrode terminal 31d covers principal surfaces on both sides of the counter electrode current collector 220 projecting adjacent to the recess 20, and is electrically connected to the principal surfaces on both sides of the counter electrode current collector 220. The counter electrode terminal 31d also covers a side surface of the counter electrode current collector 220 projecting adjacent to the recess 20. The counter electrode terminal 31d continuously covers the one principal surface, the side surface, and the other principal surface of the counter electrode current collector 220 projecting adjacent to the recess 20. The counter electrode terminal 31d is in contact with the principal surfaces on both sides and the side surface of the counter electrode current collector 220 projecting adjacent to the recess 20, for example. Moreover, the counter electrode terminal 31d is in contact with the counter electrode layer 120 inside the recess 20. In other words, the counter electrode terminal 31d covers the principal surfaces on both sides of the counter electrode current collector 220 across the entire range in a depth direction of the recess 20. This configuration makes it possible to increase a connection area between the counter electrode terminal 31d and the counter electrode current collector 220, so that the large-current characteristics of the battery 1d can be enhanced.

In the receding region 92 on the side surface 12, each electrode terminal 32d covers principal surfaces on both sides of the electrode current collector 210 projecting adjacent to the recess 20, and is electrically connected to the principal surfaces on both sides of the electrode current collector 210. The electrode terminal 32d also covers a side surface of the electrode current collector 210 projecting adjacent to the recess 20. The electrode terminal 32d continuously covers the one principal surface, the side surface, and the other principal surface of the electrode current collector 210 projecting adjacent to the recess 20. The electrode terminal 32d is in contact with the principal surfaces on both sides and the side surface of the electrode current collector 210 projecting adjacent to the recess 20, for example. Moreover, the electrode terminal 32d is in contact with the electrode layer 110 inside the recess 20. In other words, the electrode terminal 32d covers the principal surfaces on both sides of the electrode current collector 210 across the entire range in the depth direction of the recess 20. This configuration makes it possible to increase a connection area between the electrode terminal 32d and the electrode current collector 210, so that the large-current characteristics of the battery 1d can be enhanced.

### Modified Example 5

Next, Modified Example 5 of the Embodiment 1 will be described.

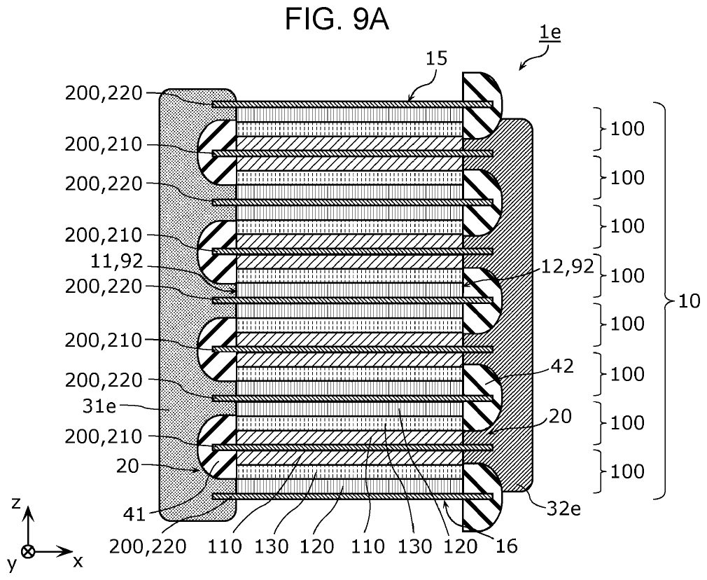

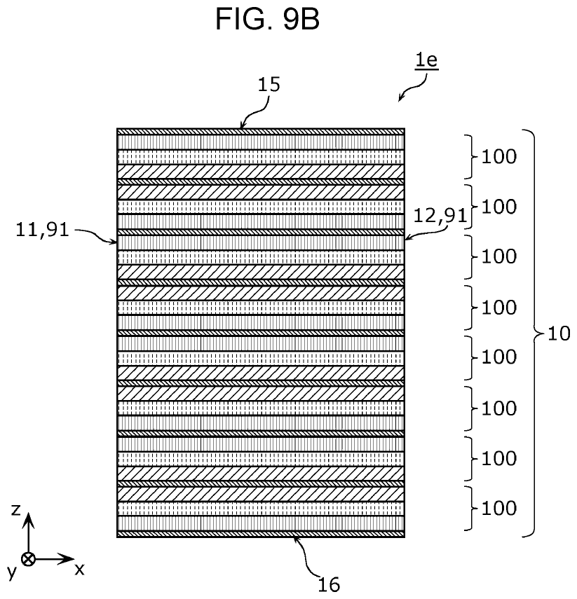

FIGS. 9A and 9B are sectional views of a battery according to the Modified Example 5 of the Embodiment 1. FIG. 9A is a sectional view at a position sectioning the receding region 92 as with FIG. 2A. Meanwhile, FIG. 9B is a sectional view at a position sectioning the continuous region 91 as with FIG. 2B.

As illustrated in FIGS. 9A and 9B, in comparison with the battery 1c according to the Modified Example 3 of the Embodiment 1, a battery 1e according to the present modified example is different in that the battery 1e includes counter electrode terminals 31e and electrode terminals 32e each representing an example of the conductive member instead of the counter electrode terminals 31 and the electrode terminals 32.

Each of the counter electrode terminals 31e and the electrode terminals 32e adopts a different layout mode as compared to the counter electrode terminals 31 and the electrode terminals 32.

On the side surface 11, the counter electrode terminal 31e covers the receding region 92 and the electrode insulating member 41 and is electrically connected to the counter electrode layer 120 and the counter electrode current collector 220. Specifically, the counter electrode terminal 31e covers the electrode insulating member 41 and a portion of the receding region 92 on the side surface 11 not covered with the electrode insulating member 41.

The counter electrode terminal 31e penetrates into each recess 20 and is in contact with principal surfaces on both sides and a side surface of the counter electrode current collector 220 as well as a side surface of the counter electrode layer 120 at the portion of the receding region 92 on the side surface 11 not covered with the electrode insulating member 41, thus being electrically connected to the principal surfaces on both sides of the counter electrode current collector 220 and to the side surface of the counter electrode layer 120. Since the counter electrode layer 120 is made of a powder material, very fine asperities are present thereon as with the solid electrolyte layer 130. Penetration of the counter electrode terminal 31e into the asperities on the side surface of the counter electrode layer 120 enhances an adhesion strength of the counter electrode terminal 31c, whereby reliability of electrical connection is improved.

The counter electrode terminals 31e are electrically connected to the respective counter electrode layers 120 of the power-generating layers 100. In other words, the counter electrode terminals 31e take on part of the function of electrically connecting the respective power-generating layers 100 in parallel. The counter electrode terminals 31e cover the receding region 92 substantially across the entire region in the direction of lamination of the power-generating element 10 in the receding region 92 in a lump.

In the power-generating element 10, each of the uppermost layer and the lowermost layer is the counter electrode current collector 220. In the vicinity of each of an upper end and a lower end of the side surface 11, the counter electrode terminal 31e covers part of the principal surface of the counter electrode current collector 220 located on each of the uppermost layer and the lowermost layer from outside. Thus, the counter electrode terminal 31e has resistance to an external force in the z-axis direction or the like, and is kept from detachment. Meanwhile, since a connection area between each counter electrode terminal 31e and the counter electrode current collector 220 is increased, a connection resistance between the counter electrode terminal 31e and the counter electrode current collector 220 is reduced so that the large-current characteristics can be enhanced.

On the side surface 12, the electrode terminal 32e covers the receding region 92 and the counter electrode insulating member 42 and is electrically connected to the electrode layer 110 and the electrode current collector 210. Specifically, the electrode terminal 32e covers the counter electrode insulating member 42 and a portion of the receding region 92 on the side surface 12 not covered with the counter electrode insulating member 42.

The electrode terminal 32e penetrates into each recess 20 and is in contact with principal surfaces on both sides and a side surface of the electrode current collector 210 as well as a side surface of the electrode layer 110 at the portion of the receding region 92 on the side surface 12 not covered with the counter electrode insulating member 42, thus being electrically connected to the principal surfaces on both sides of the electrode current collector 210 and to the side surface of the electrode layer 110. Since the electrode layer 110 is made of a powder material, very fine asperities are present thereon as with the solid electrolyte layer 130. Penetration of the electrode terminal 32e into the asperities on the side surface of the electrode layer 110 enhances an adhesion strength of the electrode terminal 32e, whereby reliability of electrical connection is improved.

The electrode terminals 32e are electrically connected to the respective electrode layers 110 of the power-generating layers 100. In other words, the electrode terminals 32e take on part of the function of electrically connecting the respective power-generating layers 100 in parallel. The electrode terminals 32e cover the receding region 92 substantially across the entire region in the direction of lamination of the power-generating element 10 in the receding region 92 in a lump.

The counter electrode terminals 31e and the electrode terminals 32e are formed by using a conductive resin material and the like. Alternatively, the counter electrode terminals 31e and the electrode terminals 32e may be formed by using a metal material such as solder. The conductive material usable therein is selected based on various characteristics including flexibility, gas barrier properties, shock resistance, heat resistance, solder wettability, and the like. The counter electrode terminals 31e and the electrode terminals 32e are formed by using the same material. Instead, the counter electrode terminals 31e may be formed by using a different material from that of the electrode terminals 32e.

Here, external electrodes may further be formed on the counter electrode terminals 31e and the electrode terminals 32e in accordance with plating, printing, soldering, and other methods. Formation of the external electrodes can improve mountability of the battery 1e, for example.

As described above, each of the counter electrode terminals 31e and the electrode terminals 32e not only functions as the extraction electrode of the battery 1e but also takes on the function to establish the parallel connection of the power-generating layers 100. Since each of the counter electrode terminals 31e and the electrode terminals 32e is formed so as to cover the receding region 92 in close contact therewith, a volume of each of these terminals can be reduced. In other words, a volumetric energy density of the battery 1e can be enhanced since the volumes of the terminals can be reduced.

### Modified Example 6

Next, Modified Example 6 of the Embodiment 1 will be described.

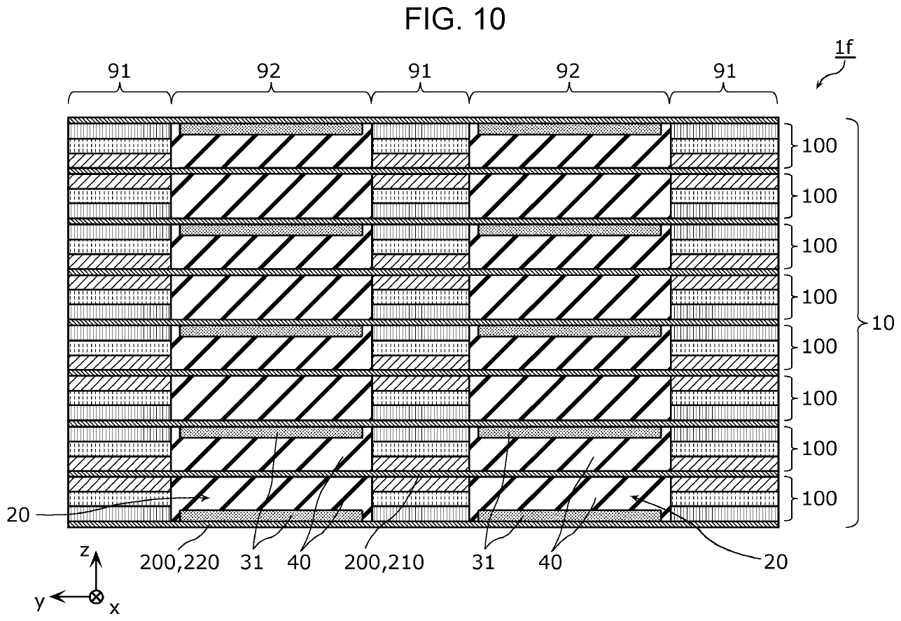

FIG. 10 is a side view of a battery according to the Modified Example 6 of the Embodiment 1. FIG. 10 is a plan view of the side surface 11 which is viewed from the front.

As illustrated in FIG. 10, in comparison with the battery 1a according to the Modified Example 1 of the Embodiment 1, a battery 1f of the present modified example is different in that receding region 92 is separated into more than one region by the continuous region 91.

In the battery 1f, part of the continuous region 91 is disposed so as to separate the receding region 92. On the side surface 11, the receding region 92 is separated into two regions by the continuous region 91. In other words, on the side surface 11, the respective power-generating layers 100 recede from the current collectors 200 adjacent to the respective power-generating layers 100 at multiple positions, whereby the respective power-generating layers 100 are provided with the recesses 20. Each of the separated receding regions 92 is sandwiched by the continuous regions 91 from both sides in the direction perpendicular to the direction of lamination of the power-generating element 10. Sectional structures obtained by cutting the respective separated receding regions 92 are the same as the sectional structure of the battery 1a illustrated in FIG. 5A, for example.

As described above, in the battery 1f, separation of the receding regions 92 reduces the width of each separated receding region 92. Accordingly, each of the current collectors 200 projecting in the receding regions 92 is less likely to move and the interval of the current collectors 200 is more appropriately maintained constant. Thus, the current collectors 200 are kept from coming into contact with each other to cause a short circuit more appropriately in the process of manufacturing the battery 1f and when the battery 1f is in use. As a consequence, reliability can be improved.

Here, the receding region 92 on the side surface 12 may also be separated into more than one region as with the case on the side surface 11.

### Modified Example 7

Next, Modified Example 7 of the Embodiment 1 will be described.

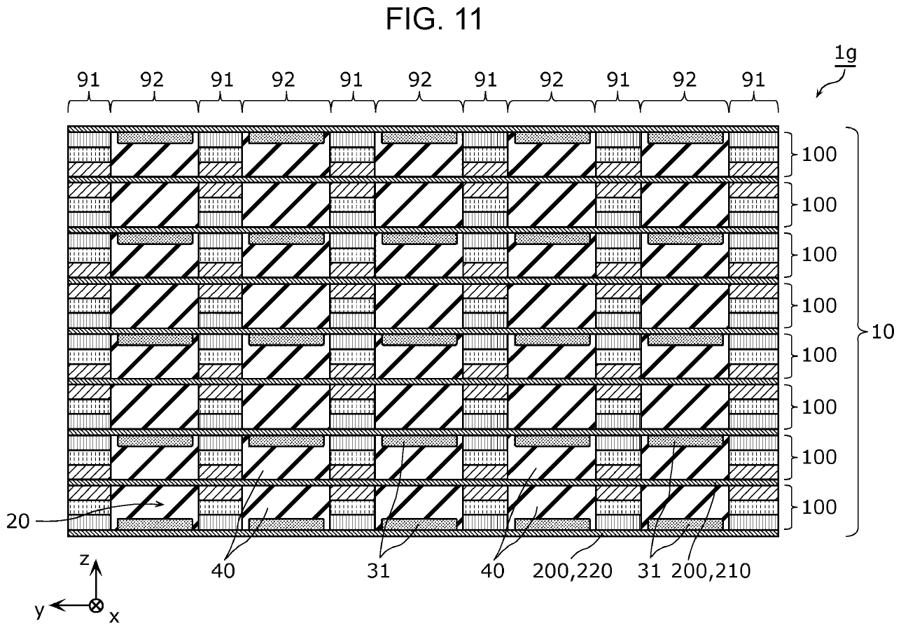

FIG. 11 is a side view of a battery according to the Modified Example 7 of the Embodiment 1. FIG. 11 is a plan view of the side surface 11 which is viewed from the front.

As illustrated in FIG. 11, in comparison with the battery 1f according to the Modified Example 6 of the Embodiment 1, a battery 1g of the present modified example is different in that the receding regions 92 are separated into more regions.

In the battery 1g, the receding regions 92 are separated into greater than or equal to three regions, or more specifically, into five regions on the side surface 11. The increase in the number of the separated receding regions 92 in comparison with the battery 1f as mentioned above further reduces the width of each separated receding region 92. Thus, the current collectors 200 are kept from coming into contact with each other to cause a short circuit even more appropriately.

Here, the receding region 92 on the side surface 12 may also be separated into greater than or equal to three regions as with the case on the side surface 11.

### Modified Example 8

Next, Modified Example 8 of the Embodiment 1 will be described.

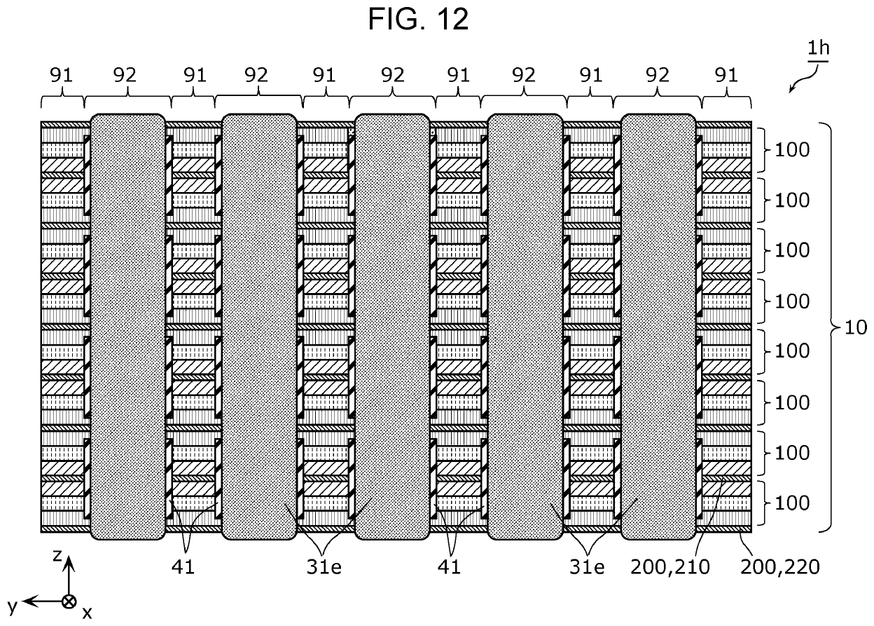

FIG. 12 is a side view of a battery according to the Modified Example 8 of the Embodiment 1. FIG. 12 is a plan view of the side surface 11 which is viewed from the front.

As illustrated in FIG. 12, in comparison with the battery 1e according to the Modified Example 5 of the Embodiment 1, a battery 1h of the present modified example is different in that the receding region 92 is separated into more than one region.

In the battery 1h, the receding region 92 is separated into greater than or equal to three regions, or more specifically, into five regions on the side surface 11. Sectional structures obtained by cutting the respective separated receding regions 92 are the same as the sectional structure of the battery 1e illustrated in FIG. 9A, for example. This configuration makes it possible to obtain a combination of the effects of the battery 1e according to the Modified Example 5 of the Embodiment 1 and of the battery 1g according to the Modified Example 7 of the Embodiment 1.

Here, the receding region 92 on the side surface 12 may also be separated into greater than or equal to three regions as with the case on the side surface 11.

### Modified Example 9

Next, Modified Example 9 of the Embodiment 1 will be described.

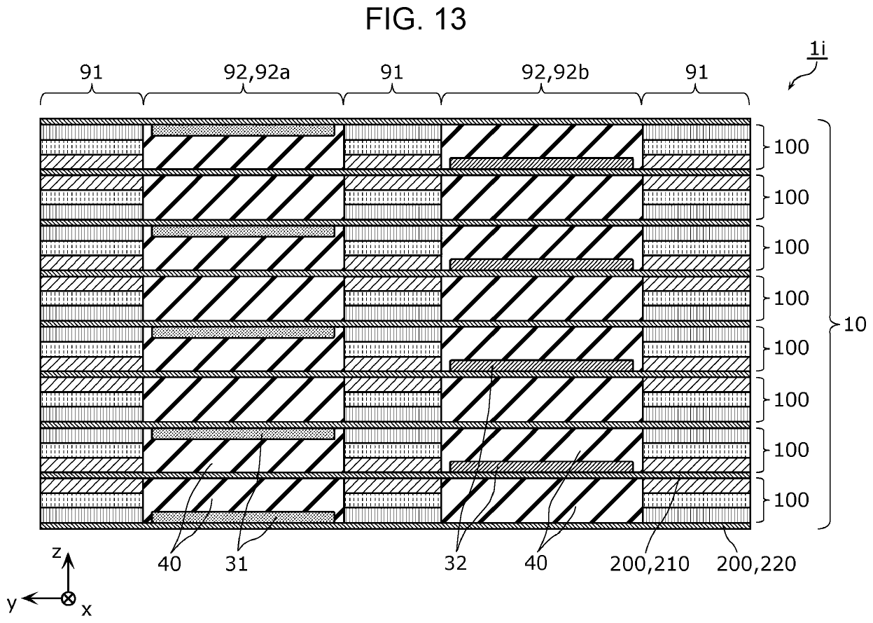

FIG. 13 is a side view of a battery according to the Modified Example 9 of the Embodiment 1. FIG. 13 is a plan view of the side surface 11 which is viewed from the front.

As illustrated in FIG. 13, in comparison with the battery 1f according to the Modified Example 6 of the Embodiment 1, a battery 1i of the present modified example is different in that the counter electrode terminals 31 are connected to one of the separated receding regions 92 and the electrode terminals 32 are connect to another one of the separated receding regions 92.

In the battery 1i, the receding regions 92 separated into the regions on the side surface 11 include a receding region 92a to which the counter electrode terminals 31 are connected and a receding region 92b to which the electrode terminals 32 are connected. A sectional structure obtained by cutting the receding region 92a is the same as the sectional structure of the receding region 92 on the side surface 11 side of the battery 1a illustrated in FIG. 5A, for example. Meanwhile, a sectional structure obtained by cutting the receding region 92b is the same as the sectional structure of the receding region 92 on the side surface 12 side of the battery 1a illustrated in FIG. 5A, for example.

As described above, in the battery 1i, both of the counter electrode terminals 31 and the electrode terminals 32 are connected to the single side surface 11. Thus, it is possible to form the terminals of the two polarities on the same surface. This configuration makes it possible to establish electrical connection between a substrate and the battery 1i easily when the battery 1i is mounted on the substrate and the like, for example.

### Modified Example 10

Next, Modified Example 10 of the Embodiment 1 will be described.

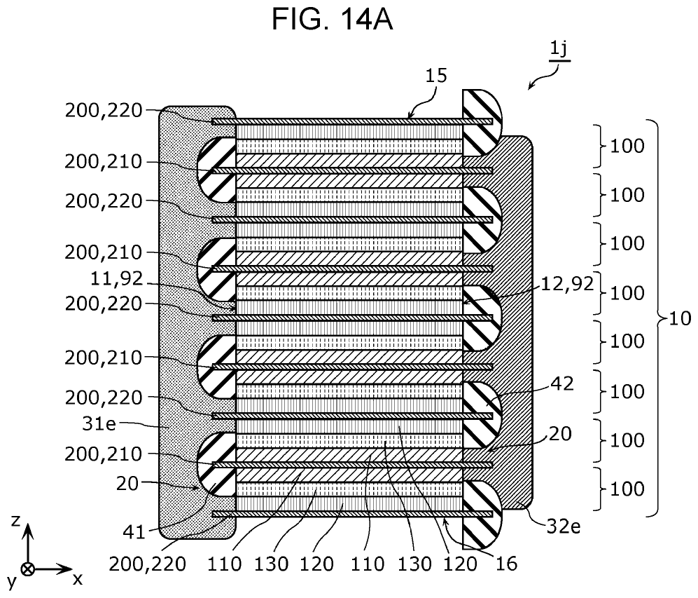

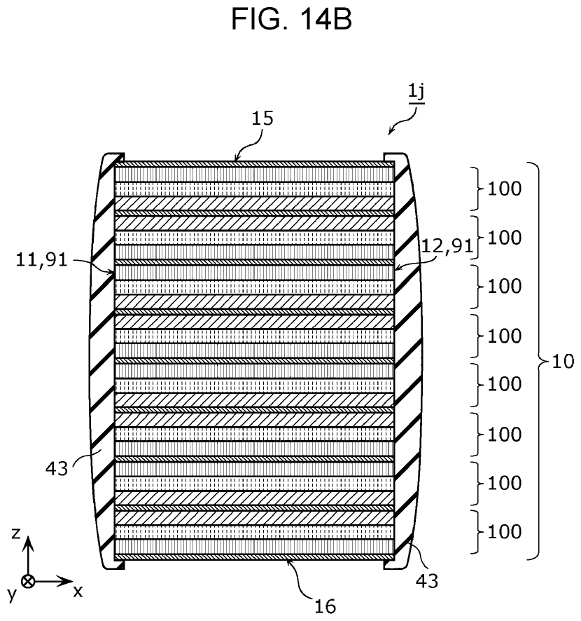

FIGS. 14A and 14B are sectional views of a battery according to the Modified Example 10 of the Embodiment 1. FIG. 14A is a sectional view at a position sectioning the receding region 92 as with FIG. 2A. Meanwhile, FIG. 14B is a sectional view at a position sectioning the continuous region 91 as with FIG. 2B.

As illustrated in FIGS. 14A and 14B, in comparison with the battery 1e according to the Modified Example 5 of the Embodiment 1, a battery 1j according to the present modified example is different in that the battery 1j further includes continuous region insulating members 43 each representing an example of the insulating member.

The continuous region insulating members 43 cover the continuous regions 91 on the side surface 11 and the side surface 12 and are in contact with the continuous regions 91. The continuous region insulating members 43 entirely cover the continuous regions 91 on the side surface 11 and the side surface 12, for example. Moreover, the continuous region insulating members 43 cover end portions of the principal surface 15 and the principal surface 16. In the meantime, although not illustrated, the continuous region insulating members 43 may cover the side surface 13 and the side surface 14.

The continuous region insulating members 43 are formed by using the same material as that of the electrode insulating members 41 and the counter electrode insulating members 42, for example. The continuous region insulating member 43 and the corresponding electrode insulating members 41, and the continuous region insulating member 43 and the corresponding counter electrode insulating members 42 may each be an integrally formed insulating member. Alternatively, the electrode insulating members 41, the counter electrode insulating members 42, and the continuous region insulating members 43 may be an insulating member that is integrally formed so as to surround an outer periphery of the power-generating element 10.

As described above, since the continuous region insulating members 43 cover the continuous regions 91, the side surfaces of the power-generating layers 100 in the continuous regions 91 are protected. Thus, it is possible to suppress collapse of the materials and a short circuit on the side surfaces of the power-generating layers 100.

### Modified Example 11

Next, Modified Example 11 of the Embodiment 1 will be described.

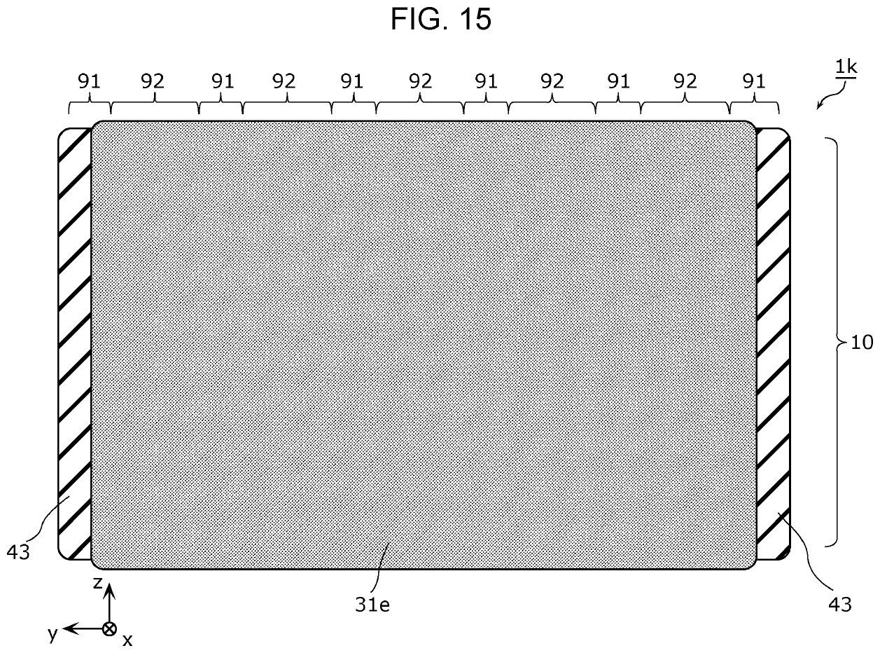

FIG. 15 is a side view of a battery according to the Modified Example 11 of the Embodiment 1. FIG. 15 is a plan view of the side surface 11 which is viewed from the front.

As illustrated in FIG. 15, in comparison with the battery 1j according to the Modified Example 10 of the Embodiment 1, a battery 1k according to the present modified example is different in that the receding region 92 is separated into more than one region and the counter electrode terminals 31e to be connected to the respective separated receding regions 92 are linked with one another.

In the battery 1k, each continuous region insulating member 43 covers not only the continuous regions 91 disposed on both ends on the side surface 11 but also the continuous regions 91 sandwiched between the receding regions 92.

The counter electrode terminals 31e cover the electrode insulating members 41, the continuous region insulating member 43, and portions of the side surface 11 not covered with the electrode insulating members 41 and the continuous region insulating member 43 in a lump. In other words, although not illustrated here, the continuous region insulating member 43 is also disposed between the counter electrode terminals 31e and the continuous regions 91 sandwiched by the receding regions 92.

The counter electrode terminals 31e are in contact with the principal surfaces on both sides and the side surface of each of the counter electrode current collectors 220 as well as the side surface of each of the counter electrode layers 120 at portions of the side surface 11 not covered with the electrode insulating members 41 and the continuous region insulating members 43, thus being electrically connected to the counter electrode current collectors 220 and the counter electrode layers 120.

The counter electrode terminals 31e are also disposed at positions covering the continuous region insulating members 43 that cover the continuous regions 91, whereby the counter electrode terminals 31e connected to the respective receding regions 92 separated into more than one region are linked with one another. In other words, the single counter electrode terminal 31e is electrically connected to the respective counter electrode layers 120 of the power-generating layers 100 in the respective receding regions 92 separated into more than one region.

As described above, since the continuous region insulating members 43 cover the continuous regions 91, it is possible to form the counter electrode terminal 31e to be connected to the separated receding regions 92 in a lump even when the receding regions 92 are separated into more than one region. This configuration facilitates formation of the counter electrode terminal 31e and extraction of the electric current by using the counter electrode terminal 31c.

Here, as with the side surface 11, the side surface 12 may also adopt a configuration in which the receding regions 92 are separated into more than one region and the electrode terminals 32e to be connected to the respective separated receding regions 92 are linked with one another.

### Modified Example 12

Next, Modified Example 12 of the Embodiment 1 will be described.

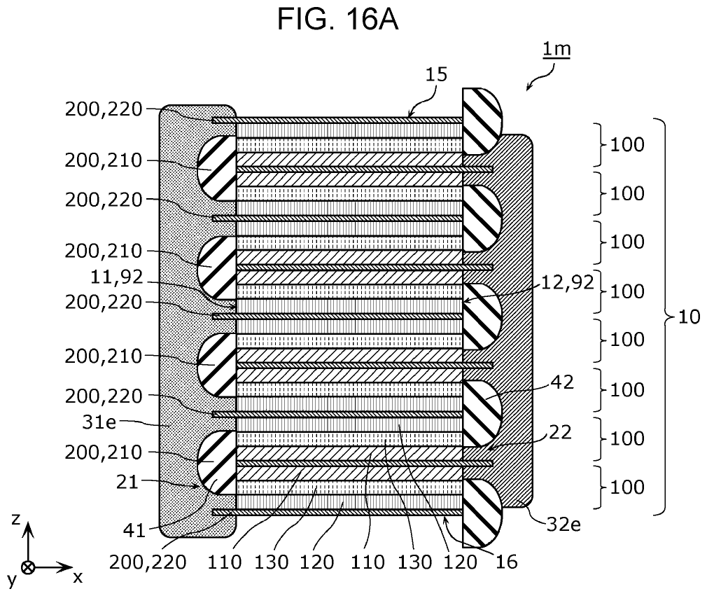

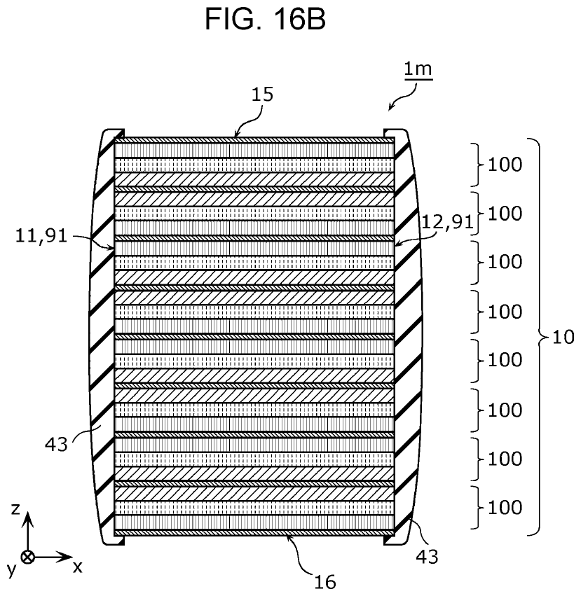

FIGS. 16A and 16B are sectional views of a battery according to the Modified Example 12 of the Embodiment 1. FIG. 16A is a sectional view at a position sectioning the receding region 92 as with FIG. 2A. Meanwhile, FIG. 16B is a sectional view at a position sectioning the continuous region 91 as with FIG. 2B.

As illustrated in FIGS. 16A and 16B, in comparison with the battery 1j according to the Modified Example 10 of the Embodiment 1, a battery Im according to the present modified example is different in that only one of the electrode current collector 210 and the counter electrode current collector 220 projects in each receding region 92.

In the receding region 92 on the side surface 11 of the battery Im, the power-generating layers 100 form recesses 21 by receding from only the counter electrode current collectors 220 out of the electrode current collectors 210 and the counter electrode current collectors 220 being adjacent to every two sides of the power-generating layers 100. In the meantime, in the receding region 92 on the side surface 11, the electrode current collectors 210 recede from the counter electrode current collectors 220 whereby the side surfaces of the electrode current collectors 210 coincide with the side surfaces of the power-generating layers 100 when viewed in the z-axis direction. Accordingly, in the receding region 92 on the side surface 11, the counter electrode current collectors 220 project from the electrode current collectors 210 and the power-generating layers 100. The projecting counter electrode current collectors 220 are covered with the counter electrode terminal 31e and are electrically connected to the counter electrode terminal 31e. As described above, since the electrode current collectors 210 do not project in the receding region 92 on the side surface 11, the electrode current collectors 210 and the counter electrode current collectors 220 are kept from coming into contact with one another and causing a short circuit in the manufacturing process and the like.

Meanwhile, in the receding region 92 on the side surface 12, the power-generating layers 100 form recesses 22 by receding from only the electrode current collectors 210 out of the electrode current collectors 210 and the counter electrode current collectors 220 being adjacent to every two sides of the power-generating layers 100. In the meantime, in the receding region 92 on the side surface 12, the counter electrode current collectors 220 recede from the electrode current collectors 210 whereby the side surfaces of the counter electrode current collectors 220 coincide with the side surfaces of the power-generating layers 100 when viewed in the z-axis direction. Accordingly, in the receding region 92 on the side surface 12, the electrode current collectors 210 project from the counter electrode current collectors 220 and the power-generating layers 100. The projecting electrode current collectors 210 are covered with the counter electrode terminal 32e and is electrically connected to the counter electrode terminal 32e. As described above, since the counter electrode current collectors 220 do not project in the receding region 92 on the side surface 12, the electrode current collectors 210 and the counter electrode current collectors 220 are kept from coming into contact with one another and causing a short circuit in the manufacturing process and the like.

In the receding regions 92 on the side surface 11, the electrode insulating members 41 cover the electrode current collectors 210 and the electrode layers 110 and are in contact with the electrode current collectors 210 and the electrode layers 110. Specifically, in the receding regions 92 on the side surface 11, each electrode insulating member 41 continuously covers the side surface of the electrode current collector 210 and the side surface or surfaces of one or two electrode layers 110 adjacent to the electrode current collector 210. In the battery Im, positions of the side surfaces of the electrode current collectors 210 are aligned and flush with positions of the side surfaces of the power-generating layers 100, so that the electrode insulating members 41 can be formed easily. Moreover, since the electrode current collectors 210 do not project from the electrode insulating members 41, the electrode current collectors 210 are kept from coming into contact with the counter electrode current collectors 220 and causing a short circuit.

In the receding regions 92 on the side surface 12, the counter electrode insulating members 42 cover the counter electrode current collectors 220 and the counter electrode layers 120 and are in contact with the counter electrode current collectors 220 and the counter electrode layers 120. Specifically, in the receding regions 92 on the side surface 12, each counter electrode insulating member 42 continuously covers the side surface of the counter electrode current collector 220 and the side surface or surfaces of one or two counter electrode layers 120 adjacent to the counter electrode current collector 220. In the battery Im, positions of the side surfaces of the counter electrode current collectors 220 are aligned and flush with positions of the side surfaces of the power-generating layers 100, so that the counter electrode insulating members 42 can be formed easily. Moreover, since the counter electrode current collectors 220 do not project from the counter electrode insulating members 42, the electrode current collectors 210 are kept from coming into contact with the counter electrode current collectors 220 and causing a short circuit.

### Modified Example 13

Next, Modified Example 13 of the Embodiment 1 will be described.

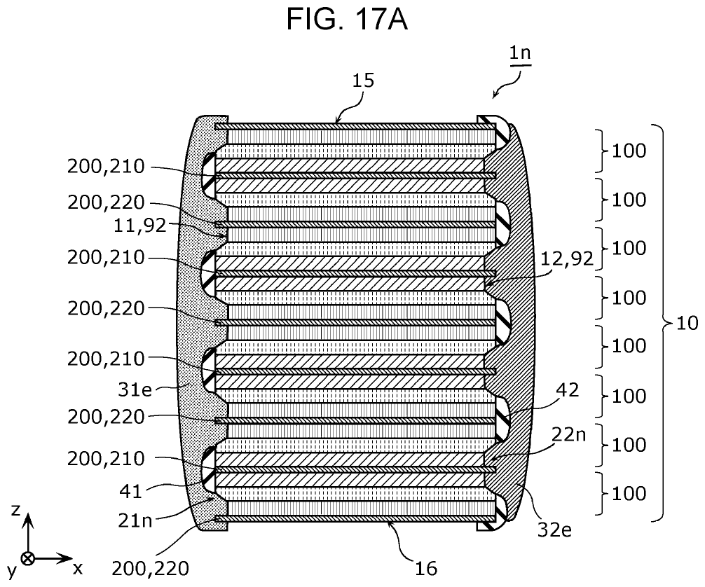

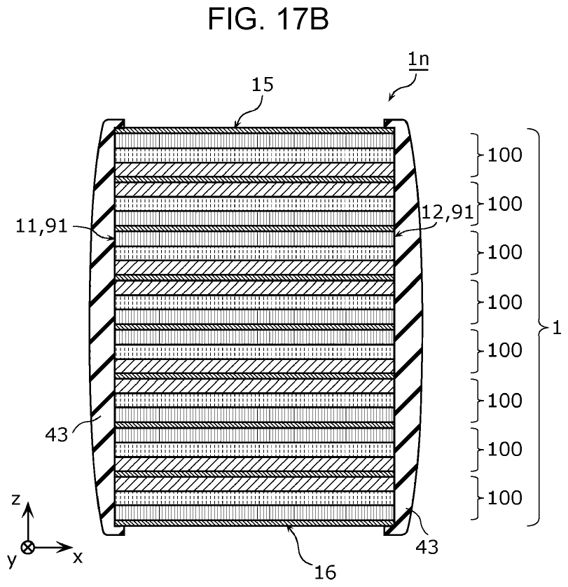

FIGS. 17A and 17B are sectional views of a battery according to the Modified Example 13 of the Embodiment 1. FIG. 17A is a sectional view at a position sectioning the receding region 92 as with FIG. 2A. Meanwhile, FIG. 17B is a sectional view at a position sectioning the continuous region 91 as with FIG. 2B.

As illustrated in FIGS. 17A and 17B, in the receding regions 92, in comparison with the battery 1j according to the Modified Example 10 of the Embodiment 1, a battery 1n according to the present modified example is different in that a certain part of the electrode layer 110, the counter electrode layer 120, and the solid electrolyte layer 130 in each power-generating layer 100 recedes from the corresponding current collector 200.

In the receding region 92 on the side surface 11 of the battery 1n, recesses 21n are formed by causing only the counter electrode layers 120 and the solid electrolyte layers 130 of the power-generating layers 100 to recede from the electrode current collectors 210 and the counter electrode current collectors 220 adjacent to both sides of the power-generating layers 100. Accordingly, in the receding region 92 on the side surface 11, the counter electrode layers 120 recede from the electrode layers 110. In the receding region 92 on the side surface 11, the entire counter electrode layers 120 recede from the electrode current collectors 210 and the counter electrode current collectors 220. Meanwhile, in the receding region 92 on the side surface 11, at least a certain part of the solid electrolyte layers 130 recedes from the electrode current collectors 210 and the counter electrode current collectors 220. Specifically, of the side surfaces of the solid electrolyte layers 130, portions not covered with the electrode insulating members 41 are obliquely inclined with respect to the z-axis direction.

Meanwhile, in the receding region 92 on the side surface 12, recesses 22n are formed by causing only the electrode layers 110 and the solid electrolyte layers 130 of the power-generating layers 100 to recede from the electrode current collectors 210 and the counter electrode current collectors 220 adjacent to both sides of the power-generating layers 100. Accordingly, in the receding region 92 on the side surface 12, the electrode layers 110 recede from the counter electrode layers 120. In the receding region 92 on the side surface 12, the entire electrode layers 110 recede from the electrode current collectors 210 and the counter electrode current collectors 220. Meanwhile, in the receding regions 92 on the side surface 12, at least a certain part of the solid electrolyte layers 130 recedes from the electrode current collectors 210 and the counter electrode current collectors 220. Specifically, of the side surfaces of the solid electrolyte layers 130, portions not covered with the counter electrode insulating members 42 are obliquely inclined with respect to the z-axis direction.

In the receding region 92 on the side surface 11, the electrode insulating members 41 cover the electrode current collectors 210 and the electrode layers 110 and are in contact with the electrode current collectors 210 and the electrode layers 110. Specifically, in the receding region 92 on the side surface 11, each electrode insulating member 41 continuously covers the side surface of the electrode current collector 210 and the side surface or surfaces of one or two electrode layers 110 adjacent to the electrode current collector 210.

In the receding region 92 on the side surface 12, the counter electrode insulating members 42 cover the counter electrode current collectors 220 and the counter electrode layers 120 and are in contact with the counter electrode current collectors 220 and the counter electrode layers 120. Specifically, in the receding region 92 on the side surface 12, each counter electrode insulating member 42 continuously covers the side surface of the counter electrode current collector 220 and the side surface or surfaces of one or two counter electrode layers 120 adjacent to the counter electrode current collector 220.

For example, the electrode insulating members 41 and the counter electrode insulating members 42 are formed on the side surface 11 and the side surface 12, respectively, and then the side surface 11 and the side surface 12 are processed in accordance with various methods so as to cause the electrode layers 110, the counter electrode layers 120, and the solid electrolyte layers 130 to recede and to cause the current collectors 200 to project relatively. In this instance, the electrode insulating members 41 and the counter electrode insulating members 42 are partially scraped off so as to slightly reduce thicknesses of the electrode insulating members 41 and the counter electrode insulating members 42, while the electrode layers 110 and the counter electrode layers 120 each made of the powder material recede faster than the current collectors 200. As a consequence, a sectional shape is formed as illustrated in FIG. 17A. Thus, it is possible to form the electrode insulating members 41 and the counter electrode insulating members 42 on the flat side surface 11 and the flat side surface 12 before providing the recesses 21n and the recesses 22n thereon, and thus to simplify the manufacturing process.

### Modified Example 14

Next, Modified Example 14 of the Embodiment 1 will be described.

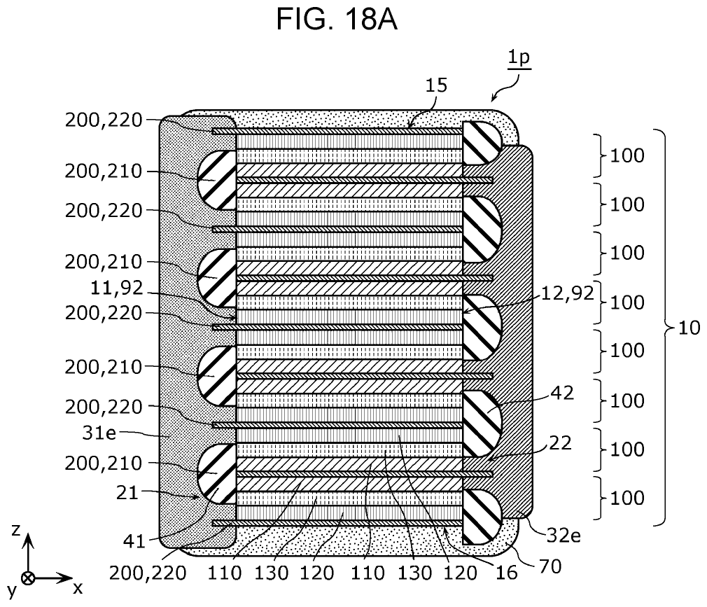

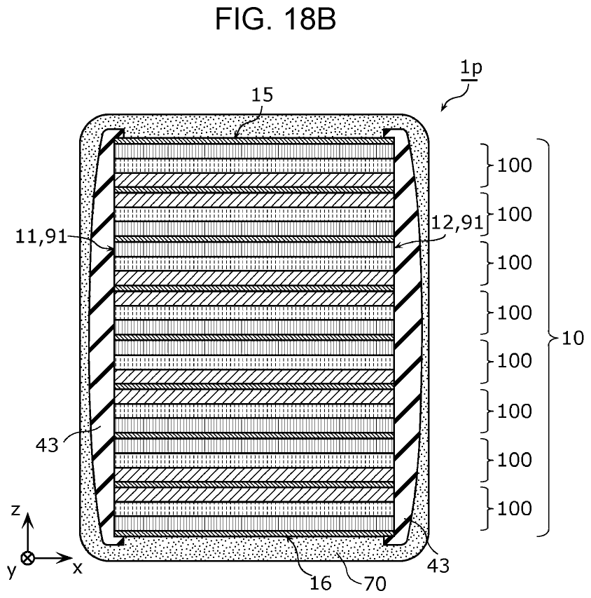

FIGS. 18A and 18B are sectional views of a battery according to the Modified Example 14 of the Embodiment 1. FIG. 18A is a sectional view at a position sectioning the receding region 92 as with FIG. 2A. Meanwhile, FIG. 18B is a sectional view at a position sectioning the continuous region 91 as with FIG. 2B.

As illustrated in FIGS. 18A and 18B, in comparison with the battery Im according to the Modified Example 12 of the Embodiment 1, a battery 1p according to the present modified example is different in that the battery 1p further includes a sealing member 70.

The sealing member 70 exposes at least part of the counter electrode terminals 31e and the electrode terminals 32e, respectively, and seals the power-generating element 10. The sealing member 70 is provided in such a way as not to expose the power-generating element 10, the electrode insulating members 41, the counter electrode insulating members 42, and the continuous region insulating members 43, for example.

The sealing member 70 is formed by using an insulating material having an electrically insulating property, for example. Publicly known materials for battery scaling members such as a sealant can be used as the insulating material. A resin material can be used as the insulating material, for example. Here, the insulating material may be an insulative and non-ion conductive material. For example, the insulating material may be at least one of epoxy resin, acrylic resin, polyimide resin, and silsesquioxane.

Here, the sealing member 70 may contain different insulating materials. For example, the sealing member 70 may have a multilayer structure. Respective layers in the multilayer structure may be formed by using different materials and have different properties.

The sealing member 70 may contain a granular metal oxide material. Such a metal oxide material usable therefor includes silicon oxide, aluminum oxide, titanium oxide, zinc oxide, cerium oxide, iron oxide, tungsten oxide, zirconium oxide, calcium oxide, zeolite, glass, and the like. For example, the sealing member 70 may be formed by using a resin material in which particles made of such a metal oxide material are dispersed.

For example, a grain size of the metal oxide material is less than or equal to an interval between the current collectors 200. For example, a shape of grains of the metal oxide material is a spherical shape, an oval spherical shape, a rod shape, and the like but is not limited to these shapes.

Provision of the sealing member 70 can improve reliability of the battery 1p in various perspectives including the mechanical strength, short-circuit prevention, moisture prevention, and so forth.

### Embodiment 2

Next, Embodiment 2 will be described. Note that the following description of the Embodiment 2 will be focused on different features from the Embodiment 1 and the respective modified examples of the Embodiment 1 while omitting or simplifying explanations of features in common. The same applies to modified examples from Modified Example 1 of the Embodiment 2 on to be described later. The description of the respective modified examples will be focused on different features from the Embodiment 1, the Embodiment 2, and the respective modified examples thereof while omitting or simplifying explanations of features in common.

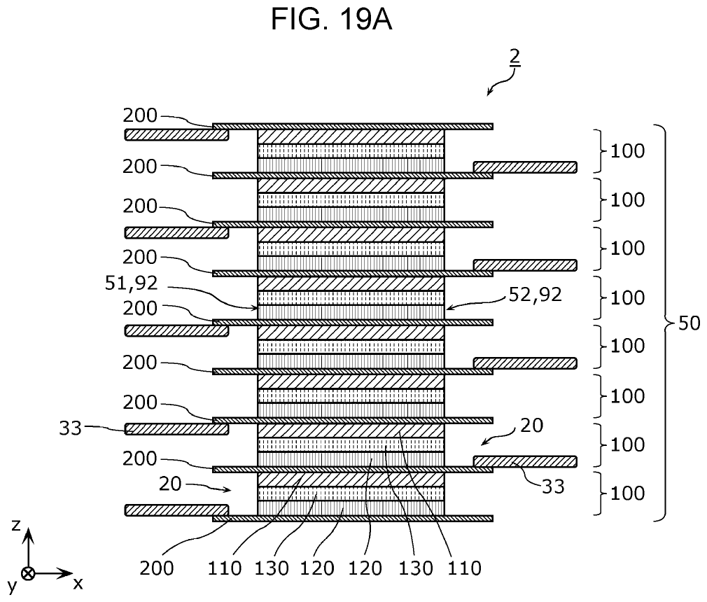

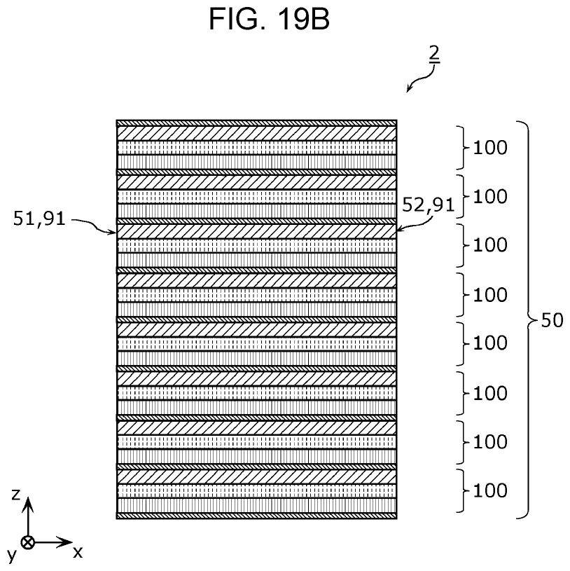

FIGS. 19A and 19B are sectional views of a battery according to the Embodiment 2. FIG. 19A is a sectional view at a position sectioning the receding region 92 as with FIG. 2A. Meanwhile, FIG. 19B is a sectional view at a position sectioning the continuous region 91 as with FIG. 2B.

As illustrated in FIGS. 19A and 19B, a battery 2 according to the present embodiment is different from the battery 1 according to the Embodiment 1 in that the battery 2 includes a power-generating element 50 instead of the power-generating element 10, and includes connection terminals 33 each representing an example of the conductive member instead of the counter electrode terminals 31 and the electrode terminals 32.

As with the power-generating element 10, the power-generating element 50 includes the power-generating layers 100 and the current collectors 200. Moreover, in the power-generating element 50, as with the power-generating element 10, the respective power-generating layers 100 among the multiple power-generating layers 100 are laminated while interposing at least one current collector 200 among the multiple current collectors 200 therebetween. Moreover, each power-generating layer 100 is sandwiched between two current collectors 200 located adjacent to each other among the multiple current collectors 200. The power-generating element 50 is different from the power-generating element 10 in that the power-generating layers 100 are laminated so as to be electrically connected in series. In the power-generating element 50, the configurations other than the order of arrangement of the respective layers constituting the power-generating layers 100 are the same as those of the power-generating element 10. In the power-generating element 50, the power-generating layers 100 are laminated in arrangement along the z axis such that the orders of arrangement of the respective layers constituting the power-generating layers 100 are the same. In this way, the power-generating layers 100 are arranged so as to be electrically connected in series. In each of the current collectors 200 among the multiple current collectors 200 except the current collectors 200 located on the uppermost portion and the lowermost portion, the electrode layer 110 is laminated on one principal surface without interposing the solid electrolyte layer 130 therebetween so as to come into contact with this principal surface, and the counter electrode layer 120 is laminated on another principal surface without interposing the solid electrolyte layer 130 therebetween so as to come into contact with this principal surface. In other words, each of the current collectors 200 among the multiple current collectors 200 except the current collectors 200 located on the uppermost portion and the lowermost portion is a bipolar current collector with the one principal surface being electrically connected to the electrode layer 110 and the other principal surface being electrically connected to the counter electrode layer 120.

The power-generating element 50 includes four side surfaces corresponding to the four side surfaces 11, 12, 13, and 14 of the power-generating element 10, and two principal surfaces corresponding to the two principal surfaces 15 and 16 of the power-generating element 10. To be more precise, as illustrated in FIGS. 19A and 19B, the power-generating element 50 includes a side surface 51 corresponding to the side surface 11 of the power-generating element 10, and a side surface 52 corresponding to the side surface 12 of the power-generating element 10.

As with the power-generating element 10, the side surface 51 and the side surface 52 in the power-generating element 50 each include the continuous region 91 and the receding region 92.

In the receding region 92, the connection terminals 33 each cover the principal surfaces of the current collectors 200 being adjacent to the respective power-generating layers 100 and are electrically connected to the principal surfaces of the current collectors 200. The connection terminals 33 are in contact with the principal surfaces of the current collectors 200, for example. In the receding region 92 on the side surface 51, each connection terminal 33 covers only the principal surface of one current collector 200 out of the two current collectors 200 being adjacent to each other. In the receding region 92 on the side surface 51, the current collectors 200 connected to the connection terminals 33 and the current collectors 200 not connected to the connection terminals 33 are alternately arranged in the z-axis direction.

Meanwhile, in the receding region 92 on the side surface 52, each connection terminal 33 covers only the principal surface of one current collector 200 out of the two current collectors 200 being adjacent to each other. In the receding region 92 on the side surface 52, the current collectors 200 connected to the connection terminals 33 and the current collectors 200 not connected to the connection terminals 33 are alternately arranged in the z-axis direction.

The above-described configuration makes it possible to reduce the number of the connection terminals 33 to be connected in the receding region 92 of each of the side surface 51 and the side surface 52. Thus, a short circuit due to contact between the connection terminals 33 is suppressed and the connection terminals 33 are formed easily when connecting the connection terminals 33 to the current collectors 200.

Meanwhile, the current collector 200 connected to the connection terminal 33 in the receding region 92 on the side surface 51 is not connected to the connection terminal 33 in the receding region 92 on the side surface 52. The current collector 200 connected to the connection terminal 33 in the receding region 92 on the side surface 52 is not connected to the connection terminal 33 in the receding region 92 on the side surface 51. In other words, one connection terminal 33 is connected to each current collector 200.

For example, each connection terminal 33 can be used for monitoring a state of each power-generating layer 100 by measuring an electric potential of the connection terminal 33, so that the connection terminal 33 can prevent overcharge and overdischarge, for example. Meanwhile, in the case where states of charge vary among the respective power-generating layers 100, it is possible to reduce the variation of the states of charge by using the connection terminals 33 for the charge and the discharge of the individual power-generating layers 100.

The connection terminals 33 are formed from the same materials and in accordance with same methods as those discussed as the examples in the description of the counter electrode terminals 31 and the electrode terminals 32, for example.

As described above, the side surface 51 and the side surface 52 include the continuous regions 91 and the receding region 92 in the battery 2 of the Embodiment 2 as well. Accordingly, as with the battery 1 of the Embodiment 1, it is possible to increase the connection area between each connection terminal 33 and the current collector 200 so that the large-current characteristics can be enhanced. Moreover, the contact between the current collectors 200 is suppressed so that reliability can be improved. In the meantime, on the side surface 51 and the side surface 52, the power-generating layers 100 recede only in the receding region 92 out of the continuous regions 91 and the receding region 92. Thus, it is possible to increase an energy density of the battery 2.

### Modified Example 1

Next, Modified Example 1 of the Embodiment 2 will be described.

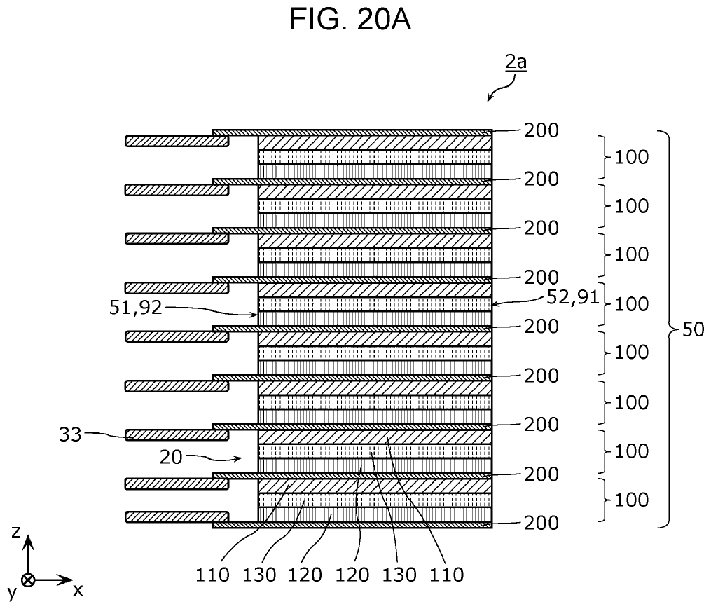

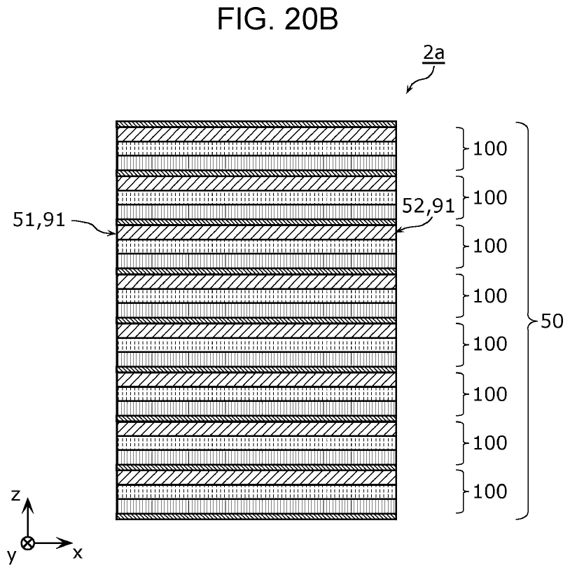

FIGS. 20A and 20B are sectional views of a battery according to the Modified Example 1 of the Embodiment 2. FIG. 20A is a sectional view at a position sectioning the receding region 92 as with FIG. 2A. Meanwhile, FIG. 20B is a sectional view at a position sectioning the continuous region 91 as with FIG. 2B.

As illustrated in FIGS. 20A and 20B, as compared to the battery 2 according to the Embodiment 2, a battery 2a according to the present modified example is different in that only the side surface 51 out of the side surface 51 and the side surface 52 includes the continuous region 91 and the receding region 92.

In the battery 2a, the side surface 51 includes the continuous region 91 and the receding region 92. In the receding region 92 on the side surface 51, respective principal surfaces of the current collectors 200 are covered with the connection terminals 33 and are electrically connected to the connection terminals 33.

In the battery 2a, the side surface 52 includes only the continuous region 91 out of the continuous region 91 and the receding region 92. For this reason, no connection terminals 33 are connected to the current collectors 200 on the side surface 52.

As described above, locations of the connection terminals 33 are aggregated on the side surface 51 side in the battery 2a. This configuration makes it easier to save space when using the battery 2a.

### Modified Example 2

Next, Modified Example 2 of the Embodiment 2 will be described.

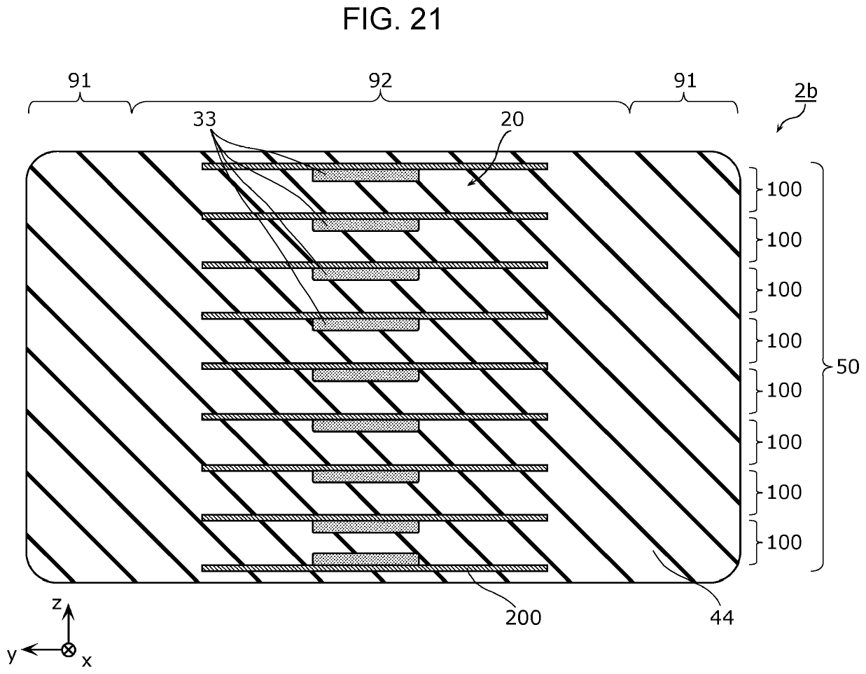

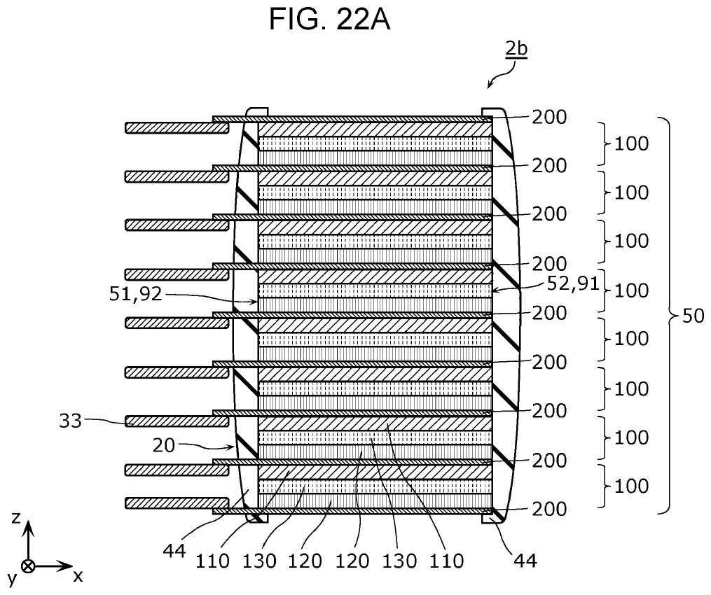

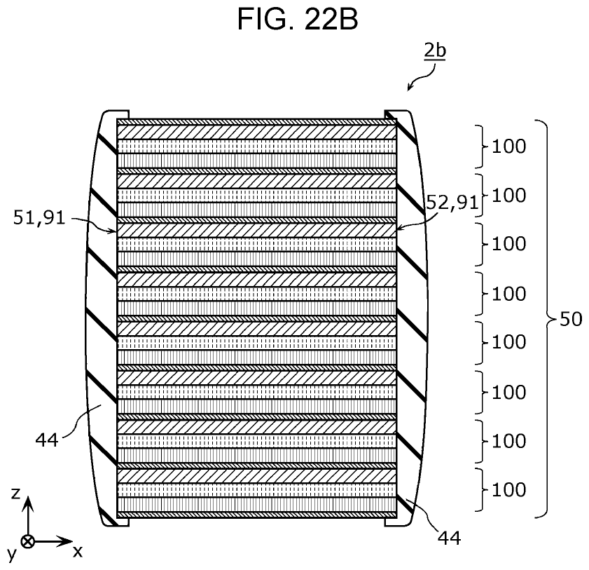

FIG. 21 is a side view of a battery according to the Modified Example 2 of the Embodiment 2. FIG. 21 is a plan view in the case of viewing the side surface 51 from the front. FIGS. 22A and 22B are sectional views of the battery according to the Modified Example 2 of the Embodiment 2. FIG. 22A is a sectional view at a position sectioning the receding region 92 as with FIG. 2A. Meanwhile, FIG. 22B is a sectional view at a position sectioning the continuous region 91 as with FIG. 2B.

As illustrated in FIGS. 21 to 22B, as compared to the battery 2a according to the Modified Example 2 of the Embodiment 2, a battery 2b according to the present modified example is different in that the battery 2b further includes insulating members 44.

The insulating members 44 cover the continuous regions 91 and the receding region 92 in a lump. Specifically, each insulating member 44 covers the side surface of each power-generating layer 100 and is in contact with the side surface of the power-generating layer 100 in the receding region 92 on the side surface 51. The insulating member 44 is an insulating layer having an insulation property, for example. In the battery 2b, the insulating member 44 is located inside the recess 20 in the receding region 92 and completely covers the side surface of each power-generating layer 100. In other words, in the recess 20, the side surface of the power-generating layer 100 is not exposed. Moreover, the insulating members 44 cover the continuous regions 91 on the side surface 51 and the side surface 52 and are in contact with the continuous regions 91. The insulating members 44 entirely cover the continuous regions 91 on the side surface 51 and the side surface 52. In addition, the insulating members 44 also cover end portions on top and bottom principal surfaces of the power-generating element 50.

Although not illustrated, the insulating members 44 may also cover any of the side surfaces of the power-generating element 50 other than the side surface 51 and the side surface 52.

The insulating members 44 are formed by using the same materials and in accordance with same methods as those discussed above in the description of the insulating members 40, for example.

Moreover, as illustrated in FIG. 21, the respective connection terminals 33 are arranged in the z-axis direction on the side surface 51.

As described above, the battery 2b can suppress collapse of the materials and the occurrence of a short circuit on the side surfaces of the power-generating layers 100 by covering the continuous regions 91 and the receding region 92 with the insulating members 44.

### Modified Example 3

Next, Modified Example 3 of the Embodiment 2 will be described.

FIG. 23 is a side view of a battery according to the Modified Example 3 of the Embodiment 2. FIG. 23 is a plan view in the case of viewing the side surface 51 from the front.

As illustrated in FIG. 23, a battery 2c according to the present modified example has a different layout of the connection terminals 33 in plan view of the side surface 51 as compared to that of the battery 2b according to the Modified Example 2 of the Embodiment 2.

As illustrated in FIG. 23, in the battery 2c, the respective connection terminals 33 are arranged on the side surface 51 in a direction inclined with respect to the z-axis direction. The respective connection terminals 33 are disposed in such a way as not to overlap one another when viewed in the z-axis direction. As described above, disposition of the connection terminals 33 being adjacent to one another at positions displaced relative to a direction along the z-axis direction makes the connection terminals 33 less likely to come into contact with one another, so that a short circuit can be suppressed.

Here, the respective connection terminals 33 may be disposed at random positions instead of being arranged in the direction inclined relative to the z-axis direction as illustrated in FIG. 23 as long as the connection terminals 33 are disposed in such a way as not to overlap one another when viewed in the z-axis direction, for example.

### Modified Example 4

Next, Modified Example 4 of the Embodiment 2 will be described.

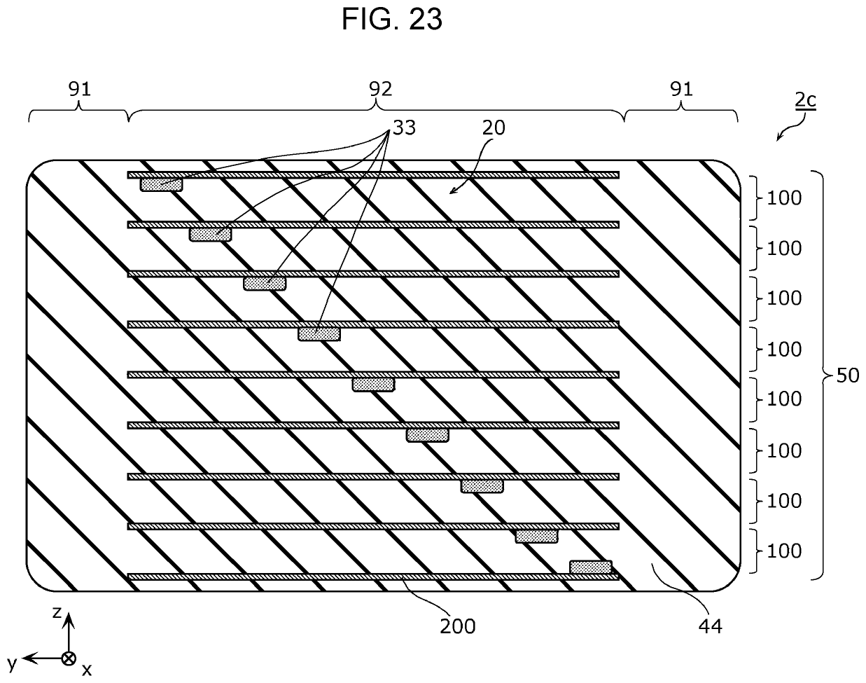

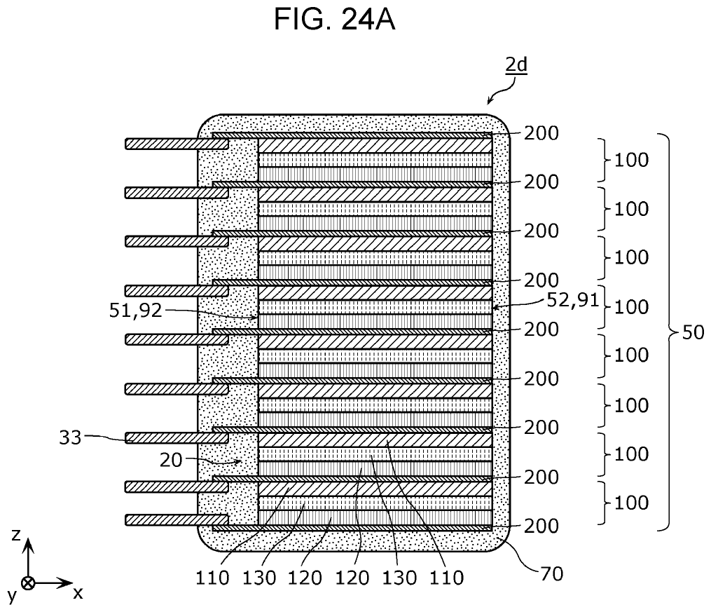

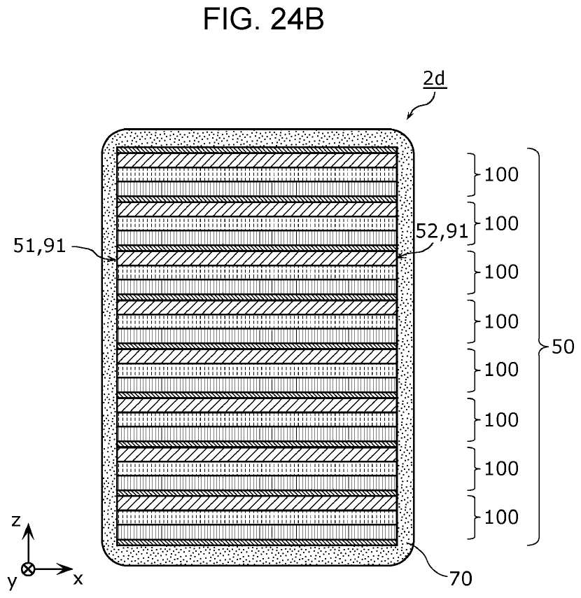

FIGS. 24A and 24B are sectional views of a battery according to the Modified Example 4 of the Embodiment 2. FIG. 24A is a sectional view at a position sectioning the receding region 92 as with FIG. 2A. Meanwhile, FIG. 24B is a sectional view at a position sectioning the continuous region 91 as with FIG. 2B.

As illustrated in FIGS. 24A and 24B, as compared to the battery 2a according to the Modified Example 1 of the Embodiment 2, a battery 2d according to the present modified example is different in that the battery 2d further includes the sealing member 70.

In the battery 2d, the sealing member 70 exposes at least part of the connection terminals 33 and seals the power-generating element 50. The sealing member 70 is provided in such a way as not to expose the power-generating element 50, for example.

Provision of the sealing member 70 can improve reliability of the battery 2d in various perspectives including the mechanical strength, short-circuit prevention, moisture prevention, and so forth.

### Manufacturing Method

Subsequently, a description will be given of a method for manufacturing the batteries according to the respective embodiments and the respective modified examples discussed above.

The method for manufacturing the batteries according to the respective embodiments and the respective modified examples includes a first step, a second step, and a third step, for example. In the first step, the multiple unit cells each having the structure in which the power-generating layer 100 and the current collector 200 are laminated are prepared. In the second step, the power-generating element 10 or 50 is formed by laminating the multiple unit cells prepared in the first step. Moreover, the second step includes providing the side surfaces of the power-generating element 10 or 50 with the continuous regions 91 in which the respective power-generating layers 100 of the multiple unit cells do not recede from the current collectors 200 located adjacent to the respective power-generating layers 100 among the current collectors 200 of the multiple unit cells, and with the receding region or regions 92 in which the recesses 20 are formed by causing the respective power-generating layers 100 of the multiple unit cells to recede from the current collectors 200 located adjacent to the respective power-generating layers 100 among the current collectors 200 of the multiple unit cells. Meanwhile, the conductive members each covering at least one of the principal surfaces of the current collector 200 out of the current collectors 200 of the multiple unit cells, which is located adjacent to the recess 20, are formed in the third step.

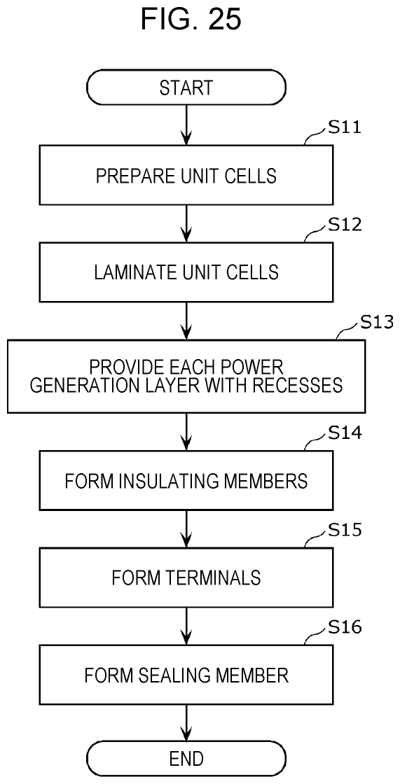

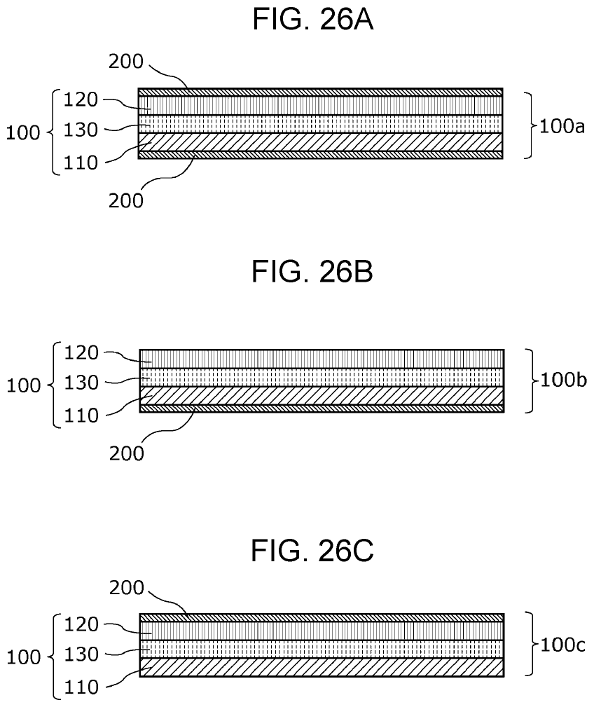

Now, the method for manufacturing the batteries according to the respective embodiments and the respective modified examples will be described in detail with reference to FIGS. 25 to 26C.

FIG. 25 is a flowchart illustrating an example of the method for manufacturing the batteries according to the respective embodiments and the respective modified examples. FIG. 25 illustrates the method for manufacturing the battery 1p, which is illustrated in FIGS. 18A and 18B, as a representative example of the batteries according to the respective embodiments and the respective modified examples. Note that the batteries according to the respective embodiments and the respective modified examples other than the battery 1p can also be manufactured by applying the respective steps described below as appropriate. In manufacturing the batteries according to the respective embodiments and the respective modified examples, any of steps illustrated in FIG. 25 may be omitted as appropriate.

In the example illustrated in FIG. 25, step S11 corresponds to the first step, steps S12 and S13 collectively correspond to the second step, and step S15 corresponds to the third step.

As illustrated in FIG. 25, the multiple unit cells each having the structure in which the power-generating layer 100 and the current collector 200 are laminated are prepared to begin with (step S11). Subsequently, the power-generating element 10 is formed by laminating the multiple unit cells thus formed (step S12). As described above, each power-generating layer 100 includes the electrode layer 110, the counter electrode layer 120 disposed opposite to the electrode layer 110, and the solid electrolyte layer 130 located between the electrode layer 110 and the counter electrode layer 120. FIGS. 26A to 26C are sectional views of respective examples of the unit cell.

As illustrated in FIG. 26A, a unit cell 100a includes one power-generating layer 100 and two current collectors 200. In the unit cell 100a, the power-generating layer 100 is disposed between the two current collectors 200 and the power-generating layer 100 is in contact with the each of the two current collectors 200. Specifically, the electrode layer 110 of the power-generating layer 100 is in contact with one of the two current collectors 200 while the counter electrode layer 120 of the power-generating layer 100 is in contact with the other one of the two current collectors 200.

In the meantime, as illustrated in FIGS. 26B and 26C, each of a unit cell 100b and a unit cell 100c includes one power-generating layer 100 and one current collector 200.

In the unit cell 100b, the current collector 200 is disposed on the electrode layer 110 side of the power-generating layer 100 so as to be opposed to the power-generating layer 100, and is in contact with the electrode layer 110. In the unit cell 100b, the principal surface of the counter electrode layer 120 of the power-generating layer 100 on the opposite side from the solid electrolyte layers 130 side is exposed.

In the unit cell 100c, the current collector 200 is disposed on the counter electrode layer 120 side of the power-generating layer 100 so as to be opposed to the power-generating layer 100, and is in contact with the counter electrode layer 120. In the unit cell 100c, the principal surface of the electrode layer 110 of the power-generating layer 100 on the opposite side from the solid electrolyte layers 130 side is exposed.

In step S12, the unit cells of at least one type out of the unit cell 100a, the unit cell 100b, and the unit cell 100c as described above are prepared in accordance with a lamination structure of the power-generating element. When forming the power-generating element 10, the single unit cell 100a, the multiple unit cells 100b, and the multiple unit cells 100c are prepared, for example. Then, the unit cell 100a is disposed on the lowermost layer and the unit cells 100b and the unit cells 100c are alternately laminated upward. In this instance, the unit cells 100b are laminated while turning the orientation illustrated in FIG. 26B upside down. Thus, the lamination structure of the power-generating element 10 is formed.

Note that the method of forming the power-generating element 10 is not limited to the above-described method. For example, the unit cell 100a may be disposed on the uppermost layer. Alternatively, the unit cell 100a may be disposed at a location different from the uppermost layer or the lowermost layer. Meanwhile, more than one unit cell 100a may be used instead. On the other hand, the single current collector 200 may be subjected to double-sided coating so as to form a set of the unit cells in which the power-generating layers 100 are laminated on the principal surfaces on both sides of the current collector 200, and the sets of the unit cells thus formed may be laminated. Otherwise, a unit cell formed from the power-generating layer 100 deprived of the current collector 200 may be used as the unit cell.

Meanwhile, the side surfaces of the power-generating element 10 may be planarized after laminating the unit cells. For example, end portions of a laminated body of the unit cells may be cut out in a lump along the direction of lamination so as to form the power-generating element 10 with the respective planarized side surfaces formed as the cut surfaces, for example. In this way, it is possible to equalize the areas of the respective layers without being affected by a variation in coating area among the respective layers. As a consequence, a variation in capacity of the battery is reduced and accuracy of the battery capacity is improved. For example, the cutting process is carried out by using a blade, a laser, waterjet, and the like.

Meanwhile, in the case of forming the power-generating element 50 as well, the power-generating element 50 can be formed by laminating the unit cells while aligning the orientations of the respective layers in the power-generating layers 100.

Next, each power-generating layer 100 is provided with the recesses 20 (step S13). Thus, the continuous regions 91 and the receding region 92 are formed on the side surface 11 and the side surface 12 of the power-generating element 10.

In step S13, the recesses 20 are formed by carrying out a recession process to cause part of the side surfaces of the power-generating layers 100 to recede, for example, and the current collectors 200 adjacent to the power-generating layers 100 project as a consequence. Meanwhile, the recesses 20 are formed at part of the side surfaces of the power-generating layers 100 except end portions in the direction perpendicular to the direction of lamination of the power-generating element 10 such that the continuous regions 91 sandwich each receding region 92 from both sides in this direction.

In the recession process, the recesses 20 are formed by subjecting the respective power-generating layers 100 to polishing, sandblasting, brushing, etching, laser irradiation, or plasma irradiation. In the recession processing, protecting members are provided to portions of the side surface 11 and the side surface 12 other than the locations to form the recesses 20 so as to cause only the desired locations to recede. In this way, the power-generating element 10 in which the continuous regions 91 and the receding region 92 are formed on the side surface 11 and the side surface 12 is obtained.

Meanwhile, in the case of forming the recesses 20 by sandblasting or brushing, the power-generating layers 100 that are more apt to be scraped off are caused to recede by using a difference in processing rate between the current collectors 200 and the power-generating layers 100, for example.

In the meantime, in the case of forming the recesses 20 by etching, the power-generating layers 100 are caused to recede by conducting the etching under conditions to render an etching rate on the current collectors 200 smaller than etching rates on the respective layers of the power-generating layers 100, for example.

On the other hand, in the case of forming the recesses 20 by laser irradiation or plasma irradiation, the power-generating layers 100 are caused to recede by conducting an irradiation process under conditions to render a processing rate on the current collectors 200 smaller than processing rates on the respective layers of the power-generating layers 100, for example.

Next, the electrode insulating members 41 and the continuous region insulating member 43 are formed on the side surface 11 of the power-generating element 10, and the counter electrode insulating members 42 and the continuous region insulating member 43 are formed on the side surface 12 of the power-generating element 10 (step S14).

The electrode insulating member 41, the counter electrode insulating members 42, and the continuous region insulating members 43 are formed by coating resin materials having fluidity and curing the resin materials, for example. The coating is carried out in accordance with an ink jet method, a spray method, a screen printing method, a gravure printing method, or the like. The curing is carried out by drying, heating, light irradiation, or the like depending on the resin materials used therein. For example, the electrode insulating members 41 and the continuous region insulating member 43 are formed by coating the same resin material in a lump. The counter electrode insulating members 42 and the continuous region insulating member 43 are also formed by coating the same resin material in a lump. The electrode insulating members 41, the counter electrode insulating members 42, and the continuous region insulating members 43 may be formed by coating the same resin material in a lump.

Here, when forming the electrode insulating members 41, the counter electrode insulating members 42, and the continuous region insulating members 43, a process to form protection members by subjecting regions not supposed to form the insulating members to a masking with a tape and the like or to a resist process, so as to keep the locations to be connected to the counter electrode terminal 31e and the electrode terminal 32e from being insulated. Electric conductivity of the locations to be connected to the terminals can be secured by removing the protection members after forming the electrode insulating members 41, the counter electrode insulating members 42, and the continuous region insulating members 43.

Note that step S13 and the step S14 can be transposed. In the case of forming the battery 1n, for example, the electrode insulating members 41, the counter electrode insulating members 42, and the continuous region insulating member 43 may be formed in advance and then the recession process may be carried out. Thus, the electrode insulating members 41, the counter electrode insulating members 42, and the continuous region insulating members 43 also function as the protection members.

Next, the counter electrode terminals 31e are formed on the side surface 11 of the power-generating element 10 and the electrode terminals 32e are formed on the side surface 12 of the power-generating element 10 (step S15). Specifically, the counter electrode terminals 31e to be electrically connected to the principal surfaces of the counter electrode current collectors 220 adjacent to the recesses 20 are formed in the receding region 92 on the side surface 11, and the electrode terminals 32e to be electrically connected to the principal surfaces of the electrode current collectors 210 adjacent to the recesses 20 are formed in the receding region on the side surface 12.

For example, the counter electrode terminals 31e are formed by coating and curing the conductive resin so as to cover the electrode insulating members 41 and the continuous region insulating member 43 as well as the portions on the side surface 11 not covered with the electrode insulating members 41 and the continuous region insulating member 43. Thus, the counter electrode terminals 31e are electrically connected to the principal surfaces of the respective counter electrode current collectors 220 of the power-generating element 10. In the meantime, the electrode terminals 32e are formed by coating and curing the conductive resin so as to cover the counter electrode insulating members 42 and the continuous region insulating member 43 as well as the portions on the side surface 12 not covered with the counter electrode insulating members 42 and the continuous region insulating member 43. Thus, the electrode terminals 32e are electrically connected to the principal surfaces of the respective electrode current collectors 210 of the power-generating element 10. Here, the counter electrode terminals 31e and the electrode terminals 32e may be formed in accordance with other methods including printing, plating, vapor deposition, sputtering, welding, soldering, bonding, and the like.

Next, the sealing member 70 for sealing the power-generating element 10 is formed (step S16). The sealing member 70 is formed by coating a resin material having fluidity at a location to form the sealing member 70 so as to expose at least part of the respective counter electrode terminals 31e and the respective electrode terminals 32e and then curing the resin material, for example. The coating is carried out in accordance with the ink jet method, the spray method, the screen printing method, the gravure printing method, or the like. The curing is carried out by drying, heating, light irradiation, or the like depending on the resin material used therein.

After the above-described processes, the battery 1p illustrated in FIGS. 18A and 18B can be manufactured.

Here, a process to press the multiple unit cells prepared in step S11 individually or after laminating the multiple unit cells may be carried out in the direction of lamination.

Meanwhile, in the example illustrated in FIG. 25, the process to provide the respective power-generating layers 100 with the recesses 20 (step S13) is carried out after the process to laminate the multiple unit cells (step S12). However, the manufacturing method is not limited to these procedures. For instance, the process to provide the respective power-generating layers 100 with the recesses 20 (step S13) may be carried out before the process to laminate the multiple unit cells (step S12). In this case, the continuous regions 91 and the receding region 92 are formed by laminating the multiple unit cells so as to arrange the recesses 20 of the respective power-generating layers 100 in the direction of lamination, for example.

In the meantime, in the recession process for forming the recesses 20 in this case, the recesses 20 may be formed by conducting partial cutting so as to leave only the current collectors 200 of the unit cells in prescribed regions in plan view of the unit cells prepared in step S11 besides the above-described example. For instance, the power-generating layers 100 of the unit cells are cut and split into pieces in the direction of lamination and the cutting is stopped just short of the current collectors 200. Then, it is possible to retain only the current collectors 200 of the unit cells in the prescribed regions in plan view by removing one of the split pieces of each of the power-generating layers 100.

### Other Embodiments

The battery according to the present disclosure has been described above based on the embodiments and the modified examples. However, the present disclosure is not limited to these embodiments and modified examples. Various modifications that are conceivable by those skilled in the art and are adopted to any of these embodiments and modified examples, as well as other modes constructed by combining certain constituents out of the embodiments and the modified examples without departing from the gist of the present disclosure are also encompassed by the scope of the present disclosure.

For example, in the embodiments and the modified examples described above, the power-generating element is formed by laminating all of the multiple power-generating layers 100 so as to be electrically connected in parallel or connected in series. However, the present disclosure is not limited to these configurations. In the power-generating element, multiple units each including the multiple power-generating layers 100 being laminated so as to be electrically connected in parallel may be laminated so as to be electrically connected in series. Alternatively, in the power-generating element, multiple units each including the multiple power-generating layers 100 being laminated so as to be electrically connected in series may be laminated so as to be electrically connected in parallel.

In the meantime, in the embodiments and the modified examples described above, the continuous regions 91 are disposed adjacent to both sides of the receding region 92. However, the present disclosure is not limited to this configuration. For example, the continuous region 91 may be disposed adjacent to only one side of the receding region 92.

Meanwhile, in the embodiments and the modified examples described above, the respective recesses 20 are arranged in the direction of lamination in the receding regions. However, the present disclosure is not limited to this configuration. For example, the locations of the respective recesses 20 may be different from one other when viewed in the direction of lamination.

In the meantime, in the embodiments and the modified examples described above, the conductive members such as the terminals are connected to the current collectors 200 in the receding region 92. However, the present disclosure is not limited to this configuration. For example, the battery does not have to include the conductive members such as the terminals, and terminals provided to a different apparatus outside the battery may be connected to the current collectors 200 in the receding region 92.

Moreover, the embodiments and the modified examples described above can implement a variety of modification, replacement, addition, omission, and the like within the scope of the appended claims and the equivalents thereof.

### INDUSTRIAL APPLICABILITY

A battery according to the present disclosure can be used as a battery for versatile applications such as electronic apparatuses, electric appliances, and electric vehicles.

What is claimed is:

1. A battery comprising:
a power-generating element having a structure in which a plurality of power-generating layers and a plurality of current collectors are laminated, wherein
each of the plurality of power-generating layers includes
an electrode layer,
a counter electrode layer, and
a solid electrolyte layer located between the electrode layer and the counter electrode layer,
the plurality of current collectors each include
a counter electrode current collector that is electrically connected to the counter electrode layer, and
an electrode current collector that is electrically connected to the electrode layer,
the plurality of power-generating layers are laminated so as to be electrically connected in parallel,
the power-generating layers being adjacent to each other are laminated while interposing at least one current collector out of the plurality of current collectors,
each of the power-generating layers of the power-generating element is sandwiched between two adjacent current collectors out of the plurality of current collectors,
a side surface of the power-generating element includes
a first region where each of the power-generating layers does not recede from the current collector out of the plurality of current collectors which is adjacent to each of the power-generating layers, and
a second region where each of the power-generating layers recedes from the current collector out of the plurality of current collectors which is adjacent to each of the power-generating layers so as to form a recess, and
the battery includes
an insulating member that covers the electrode layer and the electrode current collector in the second region, and
a conductive member that covers the second region and the insulating member, and is electrically connected to at least one of principal surfaces of the counter electrode current collector.

2. The battery according to claim 1, wherein the first regions are located on the side surface so as to sandwich the second region from both sides in a direction perpendicular to a direction of lamination of the power-generating element.

3. The battery according to claim 1, wherein the recesses formed by recession of the respective power-generating layers are arranged in the second region in a direction of lamination of the power-generating element.

4. The battery according to claim 1, wherein a maximum depth of the recess is larger than a width of the recess in a direction of lamination of the power-generating element.

5. The battery according to claim 1, wherein the second regions are separated by the first region.

6. The battery according to claim 1, wherein a length of the second region in a direction perpendicular to a direction of lamination of the power-generating element is larger than a length of the first region in the direction perpendicular to the direction of lamination of the power-generating element on the side surface.

7. The battery according to claim 1, wherein the conductive member covers principal surfaces on both sides of the current collector that is adjacent to the recess.

8. The battery according to claim 1, further comprising:
an insulating member that covers each of the power-generating layers in the second region.

9. The battery according to claim 1, wherein the counter electrode layer recedes from the electrode layer in the second region.

10. The battery according to claim 1, wherein the insulating member further covers at least part of the solid electrolyte layer in the second region.

11. The battery according to claim 8, wherein the insulating member further covers the first region.

12. A method for manufacturing a battery comprising:
a first step of preparing a plurality of unit cells each having a structure in which a power-generating layer and a current collector are laminated, the power-generating layer including an electrode layer, a counter electrode layer, and a solid electrolyte layer located between the electrode layer and the counter electrode layer; and
a second step of forming a power-generating element by laminating the plurality of unit cells, wherein
the second step is a step of connecting the plurality of unit cells in parallel and includes providing a side surface of the power-generating element with a first region where each of power-generating layers of the plurality of unit cells does not recede from the current collector located adjacent to each of the power-generating layers among the current collectors of the plurality of unit cells, and with a second region where a recess is formed by causing each of the power-generating layers to recede from the current collector located adjacent to each of the power-generating layers among the current collectors of the plurality of unit cells, and
an insulating member that covers the electrode layer and an electrode current collector being electrically connected to the electrode layer in the second region, and a conductive member that covers the second region and the insulating member and is electrically connected to at least one of principal surfaces of a counter electrode current collector being electrically connected to the counter electrode layer are provided.

13. The method for manufacturing a battery according to claim 12, wherein the recess is formed in the second step such that the first regions sandwich the second region from both sides in a direction perpendicular to a direction of lamination of the power-generating element.

14. The method for manufacturing a battery according to claim 12, wherein the recess is formed in the second step by subjecting each of the power-generating layers to any of partial cutting, polishing, sandblasting, brushing, etching, laser irradiation, and plasma irradiation.
